(19) United States
(12) Patent Application Publication
(10) Pub. No.: US 2026/0220026 A1
(43) Pub. Date: Jul. 30, 2026

(54) RUNTIME SOFTWARE BILL OF MATERIALS

(71) Applicant: Tenable, Inc., Columbia, MD (US)

(72) Inventor: Lucas TAMAGNA-DARR, Middletown, MD (US)

(21) Appl. No.: 19/041,057

(22) Filed: Jan. 30, 2025

(51) Int. Cl. G06F 11/362; G06Q 10/0875

(52) U.S. Cl. CPC G06F 11/3636; G06Q 10/0875

(57) ABSTRACT

Aspects of the disclosure are directed to a “runtime” software bill of materials (SBOM) (e.g., a SBOM for software component(s) configured for execution on an end-device). In an aspect, the runtime SBOM includes common-path rood nodes corresponding to software component(s). In an aspect, each common-path rood node is further associated with dependent node(s) corresponding to software sub-component(s). Such aspects may provide various technical advantages, such as improved vulnerability tracking, particularly for software component(s) that are released by developer(s) without a developer-generated SBOM.

### BACKGROUND OF THE DISCLOSURE

### 1. Field of the Disclosure

Aspects relate to a runtime software bill of materials (SBOM).

### 2. Description of the Related Art

With the proliferation of vulnerabilities in underlying components and libraries, it is becoming more important to understand the libraries and components an application ships with and their versions. To this end, a Software Bill of Materials (SBOM) is a list of all the components, dependencies, and metadata that make up a software product. SBOMs are similar to nutrition labels on food, listing the ingredients that make up the software.

SBOMs are important for a number of reasons, including:

Security: SBOMs help identify and manage risks in the software supply chain. They can help organizations understand the origin of each component and identify potential vulnerabilities.

Regulatory compliance: SBOMs can help organizations demonstrate transparency and control over the software components used in their applications.

Transparency: SBOMs help organizations make better security decisions based on their knowledge of the software's component parts.

Auditing: SBOMs help ensure that only authorized dependencies are included in a software project.

SBOMs include information such as: Licenses that govern the components, Versions of the components used in the code, Patch status of the components, Open-source and commercial third-party libraries, and API calls. While there is no single definitive standard for SBOMs, SBOMs typically include a description of the supplier of the software, the author of the SBOM, and the tool used to generate the SBOM. In 2021 for example, the United States Department of Commerce released guidelines that define certain minimum elements for SBOMs.

Tools exist for use by a developer (vendor or supplier) for generation of SBOMs before release (or deployment) of the software product. However, in practice, there is no enforcement mechanism for SBOMs, and many software products are released without SBOMs. Tools do not currently exist for generation of SBOMs after release (or deployment) of the software product when that software product is deployed or installed onto runtime systems that are configured to execute the software product.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method performed by a device includes populating a first software component that is configured for execution on the device as a first common-path root node of a runtime software bill of materials (SBOM); enumerating a first set of software sub-components associated with the first software component; populating, in the runtime SBOM, each software sub-component of the first set of software sub-components as a dependent node of the first common-path root node; and performing one or more actions associated with the runtime SBOM.

In an aspect, a device includes one or more memories; one or more transceivers; and one or more processors communicatively coupled to the one or more memories and the one or more transceivers, wherein the one or more processors, either alone or in combination, are configured to: populate a first software component that is configured for execution on the device as a first common-path root node of a runtime software bill of materials (SBOM); enumerate a first set of software sub-components associated with the first software component; populate in the runtime SBOM, each software sub-component of the first set of software sub-components as a dependent node of the first common-path root node; and perform one or more actions associated with the runtime SBOM.

In an aspect, a device includes means for populating a first software component that is configured for execution on the device as a first common-path root node of a runtime software bill of materials (SBOM); means for enumerating a first set of software sub-components associated with the first software component; means for populating, in the runtime SBOM, each software sub-component of the first set of software sub-components as a dependent node of the first common-path root node; and means for performing one or more actions associated with the runtime SBOM.

In an aspect, a non-transitory computer-readable medium storing computer-executable instructions that, when executed by a device, cause the device to: populate a first software component that is configured for execution on the device as a first common-path root node of a runtime software bill of materials (SBOM); enumerate a first set of software sub-components associated with the first software component; populate, in the runtime SBOM, each software sub-component of the first set of software sub-components as a dependent node of the first common-path root node; and perform one or more actions associated with the runtime SBOM.

Other objects and advantages associated with the aspects disclosed herein will be apparent to those skilled in the art based on the accompanying drawings and detailed description.

### BRIEF DESCRIPTION OF THE DRAWINGS

A more complete appreciation of the various aspects and embodiments described herein and many attendant advantages thereof will be readily obtained as the same becomes better understood by reference to the following detailed description when considered in connection with the accompanying drawings which are presented solely for illustration and not limitation, and in which:

FIG. 1 illustrates an exemplary network having various assets that can be managed using a vulnerability management system, according to various aspects.

FIG. 2 illustrates another exemplary network having various assets that can be managed using a vulnerability management system, according to various aspects.

FIG. 3 illustrates a diagram of an example system suitable for interactive remediation of vulnerabilities of web applications based on scanning of web applications.

FIG. 4 illustrates a server, according to aspects of the disclosure.

FIG. 5 generally illustrates a user equipment (UE) in accordance with aspects of the disclosure.

FIG. 6 illustrates an example neural network, according to aspects of the disclosure.

FIG. 7 illustrates cloud network architecture, in accordance with aspects of the disclosure.

FIG. 8 illustrates a process, in accordance with aspects of the disclosure.

FIG. 9 illustrates an example implementation, in accordance with aspects of the disclosure.

The accompanying drawings are presented to aid in the description of various aspects of the disclosure and are provided solely for illustration of the aspects and not limitation thereof.

### DETAILED DESCRIPTION

Various aspects and embodiments are disclosed in the following description and related drawings to show specific examples relating to exemplary aspects and embodiments. Alternate aspects and embodiments will be apparent to those skilled in the pertinent art upon reading this disclosure, and may be constructed and practiced without departing from the scope or spirit of the disclosure. Additionally, well-known elements will not be described in detail or may be omitted so as to not obscure the relevant details of the aspects and embodiments disclosed herein.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments include the discussed feature, advantage, or mode of operation.

The terminology used herein describes particular embodiments only and should not be construed to limit any embodiments disclosed herein. As used herein, the singular forms “a,” “an,” and “the” are intended to include the plural forms as well, unless the context clearly indicates otherwise. Those skilled in the art will further understand that the terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Further, various aspects and/or embodiments may be described in terms of sequences of actions to be performed by, for example, elements of a computing device. Those skilled in the art will recognize that various actions described herein can be performed by specific circuits (e.g., an application specific integrated circuit (ASIC)), by program instructions being executed by one or more processors, or by a combination of both. Additionally, these sequences of actions described herein can be considered to be embodied entirely within any form of non-transitory computer-readable medium having stored thereon a corresponding set of computer instructions that upon execution would cause an associated processor to perform the functionality described herein. Thus, the various aspects described herein may be embodied in a number of different forms, all of which have been contemplated to be within the scope of the claimed subject matter. In addition, for each of the aspects described herein, the corresponding form of any such aspects may be described herein as, for example, “logic configured to” and/or other structural components configured to perform the described action.

As used herein, the term “asset” and variants thereof may generally refer to any suitable uniquely defined electronic object that has been identified via one or more preferably unique but possibly non-unique identifiers or identification attributes (e.g., a universally unique identifier (UUID), a Media Access Control (MAC) address, a Network BIOS (NetBIOS) name, a Fully Qualified Domain Name (FQDN), an Internet Protocol (IP) address, a tag, a CPU ID, an instance ID, a Secure Shell (SSH) key, a user-specified identifier such as a registry setting, file content, information contained in a record imported from a configuration management database (CMDB), etc.). For example, the various aspects and embodiments described herein contemplate that an asset may be a physical electronic object such as, without limitation, a desktop computer, a laptop computer, a server, a storage device, a network device, a phone, a tablet, a wearable device, an Internet of Things (IoT) device, a set-top box or media player, etc. Furthermore, the various aspects and embodiments described herein contemplate that an asset may be a virtual electronic object such as, without limitation, a cloud instance, a virtual machine instance, a container, etc., a web application that can be addressed via a Uniform Resource Identifier (URI) or Uniform Resource Locator (URL), and/or any suitable combination thereof. Those skilled in the art will appreciate that the above-mentioned examples are not intended to be limiting but instead are intended to illustrate the ever-evolving types of resources that can be present in a modern computer network. As such, the various aspects and embodiments to be described in further detail below may include various techniques to manage network vulnerabilities according to an asset-based (rather than host-based) approach, whereby the various aspects and embodiments described herein contemplate that a particular asset can have multiple unique identifiers (e.g., a UUID and a MAC address) and that a particular asset can have multiples of a given unique identifier (e.g., a device with multiple network interface cards (NICs) may have multiple unique MAC addresses). Furthermore, as will be described in further detail below, the various aspects and embodiments described herein contemplate that a particular asset can have one or more dynamic identifiers that can change over time (e.g., an IP address) and that different assets may share a non-unique identifier (e.g., an IP address can be assigned to a first asset at a first time and assigned to a second asset at a second time). Accordingly, the identifiers or identification attributes used to define a given asset may vary with respect to uniqueness and the probability of multiple occurrences, which may be taken into consideration in reconciling the particular asset to which a given data item refers. Furthermore, in the elastic licensing model described herein, an asset may be counted as a single unit of measurement for licensing purposes. Further, assets may encompass tangential network aspects such as policies, rules and so forth.

Assets may also be implemented within or as part of cloud network architecture (e.g., cloud assets may correspond to instances or virtual machines (VMs), particular devices or groups of devices, distributed resources across multiple devices and/or locations, etc.) By way of examples, cloud assets may include, but are not limited to, any of the following examples which are characterized with respect to AMAZON, GOOGLE and MICROSOFT cloud services (e.g., Amazin Web Services, Microsoft Azure, Google Cloud), e.g.:
‘aws_athena_database’
‘aws_db_instance’
‘aws_db_snapshot’
‘aws_dynamodb_table’
‘aws_ecr_repository’
‘aws_ecr_repository_policy’
‘aws_ecs_cluster’
‘aws_ecs_service’
‘aws_eks_cluster’
‘aws_elb’
‘aws_emr_cluster’
‘aws_instance’
‘aws_nat_gateway’
‘aws_rds_cluster’
‘aws_rds_cluster_instance’
‘aws_redshift_cluster’
‘aws_s3_bucket’
‘aws_s3_bucket_policy’
‘azurerm_container_group’
‘azurerm_container_registry’
‘azurerm_kubernetes_cluster’
‘azurerm_lb’
‘azurerm_linux_virtual_machine’
‘azurerm_mariadb_server’
‘azurerm_mssql_server’
‘azurerm_mssql_virtual_machine’
‘azurerm_mysql_database’
‘azurerm_mysql_server’
‘azurerm_postgresql_database’
‘azurerm_postgresql_server’
‘azurerm_sql_database’
‘azurerm_sql_server’
‘azurerm_storage_container’
‘azurerm_virtual_machine_scale_set’
‘azurerm_windows_virtual_machine’
‘google_bigquery_dataset’
‘google_bigquery_table’
‘google_compute_forwarding_rule’
‘google_compute_global_forwarding_rule’
‘google_compute_instance’
‘google_container_cluster’
‘google_container_registry’
‘google_sql_database’
‘google_sql_database_instance’
‘google_storage_bucket’
‘kubernetes_cluster’
‘kubernetes_pod’

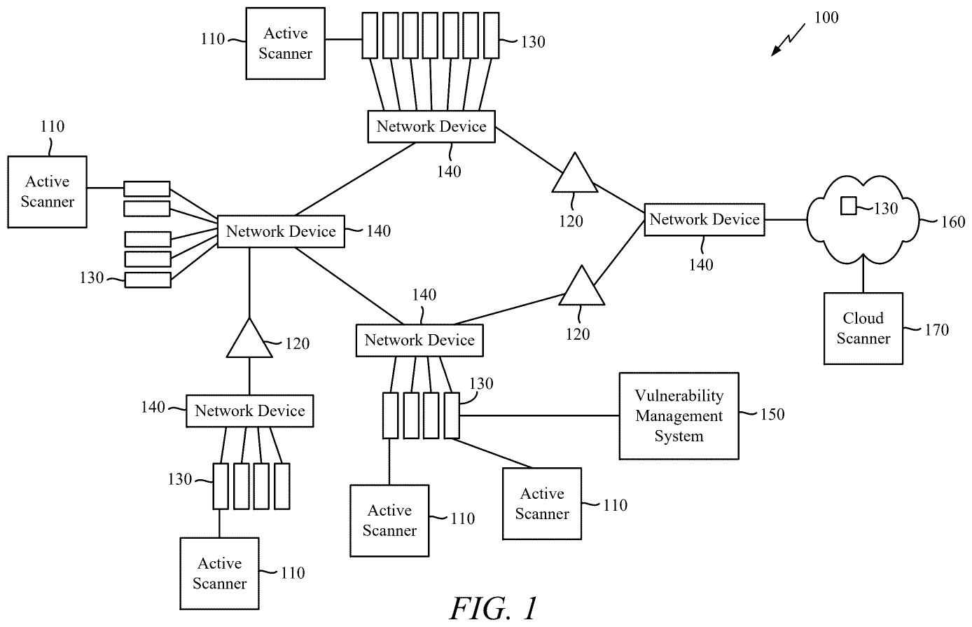

According to various aspects, FIG. 1 illustrates an exemplary network 100 having various assets 130 that are interconnected via one or more network devices 140 and managed using a vulnerability management system 150. More particularly, as noted above, the assets 130 may include various types, including traditional assets (e.g., physical desktop computers, servers, storage devices, etc.), web applications that run self-supporting code, Internet of Things (IoT) devices (e.g., consumer appliances, conference room utilities, cars parked in office lots, physical security systems, etc.), mobile or bring-your-own-device (BYOD) resources (e.g., laptop computers, mobile phones, tablets, wearables, etc.), virtual objects (e.g., containers and/or virtual machine instances that are hosted within the network 100, cloud instances hosted in off-site server environments, etc.). Those skilled in the art will appreciate that the assets 130 listed above are intended to be exemplary only and that the assets 130 associated with the network 100 may include any suitable combination of the above-listed asset types and/or other suitable asset types. Furthermore, in various embodiments, the one or more network devices 140 may include wired and/or wireless access points, small cell base stations, network routers, hubs, spanned switch ports, network taps, choke points, and so on, wherein the network devices 140 may also be included among the assets 130 despite being labelled with a different reference numeral in FIG. 1.

According to various aspects, the assets 130 that make up the network 100 (including the network devices 140 and any assets 130 such as cloud instances that are hosted in an off-site server environment or other remote network 160) may collectively form an attack surface that represents the sum total of resources through which the network 100 may be vulnerable to a cyberattack. As will be apparent to those skilled in the art, the diverse nature of the various assets 130 make the network 100 substantially dynamic and without clear boundaries, whereby the attack surface may expand and contract over time in an often unpredictable manner thanks to trends like BYOD and DevOps, thus creating security coverage gaps and leaving the network 100 vulnerable. For example, due at least in part to exposure to the interconnectedness of new types of assets 130 and abundant software changes and updates, traditional assets like physical desktop computers, servers, storage devices, and so on are more exposed to security vulnerabilities than ever before. Moreover, vulnerabilities have become more and more common in self-supported code like web applications as organizations seek new and innovative ways to improve operations. Although delivering custom applications to employees, customers, and partners can increase revenue, strengthen customer relationships, and improve efficiency, these custom applications may have flaws in the underlying code that could expose the network 100 to an attack. In other examples, IoT devices are growing in popularity and address modern needs for connectivity but can also add scale and complexity to the network 100, which may lead to security vulnerabilities as IoT devices are often designed without security in mind. Furthermore, trends like mobility, BYOD, etc. mean that more and more users and devices may have access to the network 100, whereby the idea of a static network with devices that can be tightly controlled is long gone. Further still, as organizations adopt DevOps practices to deliver applications and services faster, there is a shift in how software is built and short-lived assess like containers and virtual machine instances are used. While these types of virtual assets can help organizations increase agility, they also create significant new exposure for security teams. Even the traditional idea of a perimeter for the network 100 is outdated, as many organizations are connected to cloud instances that are hosted in off-site server environments, increasing the difficulty to accurately assess vulnerabilities, exposure, and overall risk from cyberattacks that are also becoming more sophisticated, more prevalent, and more likely to cause substantial damage.

Accordingly, to address the various security challenges that may arise due to the network 100 having an attack surface that is substantially elastic, dynamic, and without boundaries, the vulnerability management system 150 may include various components that are configured to help detect and remediate vulnerabilities in the network 100.

More particularly, the network 100 may include one or more active scanners 110 configured to communicate packets or other messages within the network 100 to detect new or changed information describing the various network devices 140 and other assets 130 in the network 100. For example, in one implementation, the active scanners 110 may perform credentialed audits or uncredentialed scans to scan certain assets 130 in the network 100 and obtain information that may then be analyzed to identify potential vulnerabilities in the network 100. As used herein “credentialed” scans rely upon user credential(s) for authentication. Credentialed scans can perform a wider variety of checks than non-credentialed scans, which can result in more accurate scan results. Non-credentialed scans by contrast do not rely upon user credential(s) for authentication. More particularly, in one implementation, the credentialed audits may include the active scanners 110 using suitable authentication technologies to log into and obtain local access to the assets 130 in the network 100 and perform any suitable operation that a local user could perform thereon without necessarily requiring a local agent. Alternatively and/or additionally, the active scanners 110 may include one or more agents (e.g., lightweight programs) locally installed on a suitable asset 130 and given sufficient privileges to collect vulnerability, compliance, and system data to be reported back to the vulnerability management system 150. As such, the credentialed audits performed with the active scanners 110 may generally be used to obtain highly accurate host-based data that includes various client-side issues (e.g., missing patches, operating system settings, locally running services, etc.). On the other hand, the uncredentialed audits may generally include network-based scans that involve communicating packets or messages to the appropriate asset(s) 130 and observing responses thereto in order to identify certain vulnerabilities (e.g., that a particular asset 130 accepts spoofed packets that may expose a vulnerability that can be exploited to close established connections). Furthermore, as shown in FIG. 1, one or more cloud scanners 170 may be configured to perform a substantially similar function as the active scanners 110, except that the cloud scanners 170 may also have the ability to scan assets 130 like cloud instances that are hosted in a remote network 160 (e.g., an off-site server environment or other suitable cloud infrastructure).

Additionally, in various implementations, one or more passive scanners 120 may be deployed within the network 100 to observe or otherwise listen to traffic in the network 100, to identify further potential vulnerabilities in the network 100, and to detect activity that may be targeting or otherwise attempting to exploit previously identified vulnerabilities. In one implementation, as noted above, the active scanners 110 may obtain local access to one or more of the assets 130 in the network 100 (e.g., in a credentialed audit) and/or communicate various packets or other messages within the network 100 to illicit responses from one or more of the assets 130 (e.g., in an uncredentialed scan). In contrast, the passive scanners 120 may generally observe (or “sniff”) various packets or other messages in the traffic traversing the network 100 to passively scan the network 100. In particular, the passive scanners 120 may reconstruct one or more sessions in the network 100 from information contained in the sniffed traffic, wherein the reconstructed sessions may then be used in combination with the information obtained with the active scanners 110 to build a model or topology describing the network 100. For example, in one implementation, the model or topology built from the information obtained with the active scanners 110 and the passive scanners 120 may describe any network devices 140 and/or other assets 130 that are detected or actively running in the network 100, any services or client-side software actively running or supported on the network devices 140 and/or other assets 130, and trust relationships associated with the various network devices 140 and/or other assets 130, among other things. In one implementation, the passive scanners 120 may further apply various signatures to the information in the observed traffic to identify vulnerabilities in the network 100 and determine whether any data in the observed traffic potentially targets such vulnerabilities. In one implementation, the passive scanners 120 may observe the network traffic continuously, at periodic intervals, on a pre-configured schedule, or in response to determining that certain criteria or conditions have been satisfied. The passive scanners 120 may then automatically reconstruct the network sessions, build or update the network model, identify the network vulnerabilities, and detect the traffic potentially targeting the network vulnerabilities in response to new or changed information in the network 100.

In one implementation, as noted above, the passive scanners 120 may generally observe the traffic traveling across the network 100 to reconstruct one or more sessions occurring in the network 100, which may then be analyzed to identify potential vulnerabilities in the network 100 and/or activity targeting the identified vulnerabilities, including one or more of the reconstructed sessions that have interactive or encrypted characteristics (e.g., due to the sessions including packets that had certain sizes, frequencies, randomness, or other qualities that may indicate potential backdoors, covert channels, or other vulnerabilities in the network 100). Accordingly, the passive scanners 120 may monitor the network 100 in substantially real-time to detect any potential vulnerabilities in the network 100 in response to identifying interactive or encrypted sessions in the packet stream (e.g., interactive sessions may typically include activity occurring through keyboard inputs, while encrypted sessions may cause communications to appear random, which can obscure activity that installs backdoors or rootkit applications). Furthermore, in one implementation, the passive scanners 120 may identify changes in the network 100 from the encrypted and interactive sessions (e.g., an asset 130 corresponding to a new e-commerce server may be identified in response to the passive scanners 120 observing an encrypted and/or interactive session between a certain host located in the remote network 160 and a certain port that processes electronic transactions). In one implementation, the passive scanners 120 may observe as many sessions in the network 100 as possible to provide optimal visibility into the network 100 and the activity that occurs therein. For example, in one implementation, the passive scanners 120 may be deployed at any suitable location that enables the passive scanners 120 to observe traffic going into and/or out of one or more of the network devices 140. In one implementation, the passive scanners 120 may be deployed on any suitable asset 130 in the network 100 that runs a suitable operating system (e.g., a server, host, or other device that runs Red Hat Linux or FreeBSD open source operating system, a UNIX, Windows, or Mac OS X operating system, etc.).

Furthermore, in one implementation, the various assets and vulnerabilities in the network 100 may be managed using the vulnerability management system 150, which may provide a unified security monitoring solution to manage the vulnerabilities and the various assets 130 that make up the network 100. In particular, the vulnerability management system 150 may aggregate the information obtained from the active scanners 110 and the passive scanners 120 to build or update the model or topology associated with the network 100, which may generally include real-time information describing various vulnerabilities, applied or missing patches, intrusion events, anomalies, event logs, file integrity audits, configuration audits, or any other information that may be relevant to managing the vulnerabilities and assets in the network 100. As such, the vulnerability management system 150 may provide a unified interface to mitigate and manage governance, risk, and compliance in the network 100.

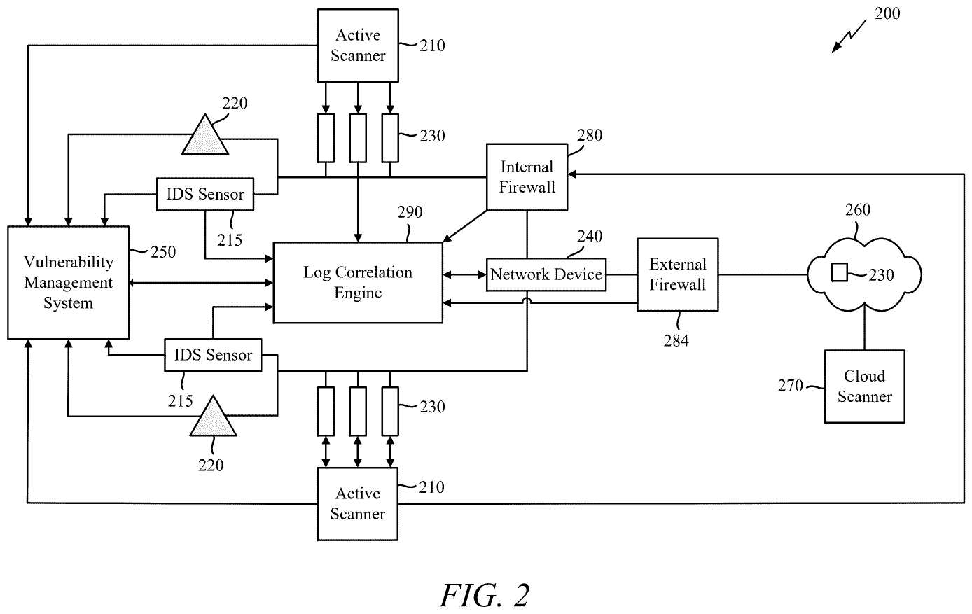

According to various aspects, FIG. 2 illustrates another exemplary network 200 with various assets 230 that can be managed using a vulnerability management system 250. In particular, the network 200 shown in FIG. 2 may have various components and perform substantially similar functionality as described above with respect to the network 100 shown in FIG. 1. For example, in one implementation, the network 200 may include one or more active scanners 210 and/or cloud scanners 270, which may interrogate assets 230 in the network 200 to build a model or topology of the network 200 and identify various vulnerabilities in the network 200, one or more passive scanners 220 that can passively observe traffic in the network 200 to further build the model or topology of the network 200, identify further vulnerabilities in the network 200, and detect activity that may potentially target or otherwise exploit the vulnerabilities. Additionally, in one implementation, a log correlation engine 290 may be arranged to receive logs containing events from various sources distributed across the network 200. For example, in one implementation, the logs received at the log correlation engine 290 may be generated by internal firewalls 280, external firewalls 284, network devices 240, assets 230, operating systems, applications, or any other suitable resource in the network 200. Accordingly, in one implementation, the information obtained from the active scanners 210, the cloud scanners 270, the passive scanners 220, and the log correlation engine 290 may be provided to the vulnerability management system 250 to generate or update a comprehensive model associated with the network 200 (e.g., topologies, vulnerabilities, assets, etc.).

In one implementation, the active scanners 210 may be strategically distributed in locations across the network 200 to reduce stress on the network 200. For example, the active scanners 210 may be distributed at different locations in the network 200 in order to scan certain portions of the network 200 in parallel, whereby an amount of time to perform the active scans may be reduced. Furthermore, in one implementation, one or more of the active scanners 210 may be distributed at a location that provides visibility into portions of a remote network 260 and/or offloads scanning functionality from the managed network 200. For example, as shown in FIG. 2, one or more cloud scanners 270 may be distributed at a location in communication with the remote network 260, wherein the term “remote network” as used herein may refer to the Internet, a partner network, a wide area network, a cloud infrastructure, and/or any other suitable external network. As such, the terms “remote network,” “external network,” “partner network,” and “Internet” may all be used interchangeably to suitably refer to one or more networks other than the networks 100, 200 that are managed using the vulnerability management systems 150, 250, while references to “the network” and/or “the internal network” may generally refer to the areas that the systems and methods described herein may be used to protect or otherwise manage. Accordingly, in one implementation, limiting the portions in the managed network 200 and/or the remote network 260 that the active scanners 210 are configured to interrogate, probe, or otherwise scan and having the active scanners 210 perform the scans in parallel may reduce the amount of time that the active scans consume because the active scanners 210 can be distributed closer to scanning targets. In particular, because the active scanners 210 may scan limited portions of the network 200 and/or offload scanning responsibility to the cloud scanners 270, and because the parallel active scans may obtain information from the different portions of the network 200, the overall amount of time that the active scans consume may substantially correspond to the amount of time associated with one active scan.

As such, in one implementation, the active scanners 210 and/or cloud scanners 270 may generally scan the respective portions of the network 200 to obtain information describing vulnerabilities and assets in the respective portions of the network 200. In particular, the active scanners 210 and/or cloud scanners 270 may perform the credentialed and/or uncredentialed scans in the network in a scheduled or distributed manner to perform patch audits, web application tests, operating system configuration audits, database configuration audits, sensitive file or content searches, or other active probes to obtain information describing the network. For example, the active scanners 210 and/or cloud scanners 270 may conduct the active probes to obtain a snapshot that describes assets actively running in the network 200 at a particular point in time (e.g., actively running network devices 240, internal firewalls 280, external firewalls 284, and/or other assets 230). In various embodiments, the snapshot may further include any exposures that the actively running assets to vulnerabilities identified in the network 200 (e.g., sensitive data that the assets contain, intrusion events, anomalies, or access control violations associated with the assets, etc.), configurations for the actively running assets (e.g., operating systems that the assets run, whether passwords for users associated with the assets comply with certain policies, whether assets that contain sensitive data such as credit card information comply with the policies and/or industry best practices, etc.), or any other information suitably describing vulnerabilities and assets actively detected in the network 200. In one implementation, in response to obtaining the snapshot of the network 200, the active scanners 210 and/or cloud scanners 270 may then report the information describing the snapshot to the vulnerability management system 250, which may use the information provided by the active scanners 210 to remediate and otherwise manage the vulnerabilities and assets in the network.

Furthermore, in one implementation, the passive scanners 220 may be distributed at various locations in the network 200 to monitor traffic traveling across the network 200, traffic originating within the network 200 and directed to the remote network 260, and traffic originating from the remote network 260 and directed to the network 200, thereby supplementing the information obtained with the active scanners 210. For example, in one implementation, the passive scanners 220 may monitor the traffic traveling across the network 200 and the traffic originating from and/or directed to the remote network 260 to identify vulnerabilities, assets, or information that the active scanners 210 may be unable to obtain because the traffic may be associated with previously inactive assets that later participate in sessions on the network. Additionally, in one implementation, the passive scanners 220 may be deployed directly within or adjacent to an intrusion detection system sensor 215, which may provide the passive scanners 220 with visibility relating to intrusion events or other security exceptions that the intrusion detection system (IDS) sensor 215 identifies. In one implementation, the IDS may be an open source network intrusion prevention and detection system (e.g., Snort), a packet analyzer, or any other system that having a suitable IDS sensor 215 that can detect and prevent intrusion or other security events in the network 200.

Accordingly, in various embodiments, the passive scanners 220 may sniff one or more packets or other messages in the traffic traveling across, originating from, or directed to the network 200 to identify new network devices 240, internal firewalls 280, external firewalls 284, or other assets 230 in addition to open ports, client/server applications, any vulnerabilities, or other activity associated therewith. In addition, the passive scanners 220 may further monitor the packets in the traffic to obtain information describing activity associated with web sessions, Domain Name System (DNS) sessions, Server Message Block (SMB) sessions, File Transfer Protocol (FTP) sessions, Network File System (NFS) sessions, file access events, file sharing events, or other suitable activity that occurs in the network 200. In one implementation, the information that the passive scanners 220 obtains from sniffing the traffic traveling across, originating from, or directed to the network 200 may therefore provide a real-time record describing the activity that occurs in the network 200. Accordingly, in one implementation, the passive scanners 220 may behave like a security motion detector on the network 200, mapping and monitoring any vulnerabilities, assets, services, applications, sensitive data, and other information that newly appear or change in the network 200. The passive scanners 220 may then report the information obtained from the traffic monitored in the network to the vulnerability management system 250, which may use the information provided by the passive scanners 220 in combination with the information provided from the active scanners 210 to remediate and otherwise manage the network 200.

In one implementation, as noted above, the network 200 shown in FIG. 2 may further include a log correlation engine 290, which may receive logs containing one or more events from various sources distributed across the network 200 (e.g., logs describing activities that occur in the network 200, such as operating system events, file modification events, USB device insertion events, etc.). In particular, the logs received at the log correlation engine 290 may include events generated by one or more of the internal firewalls 280, external firewalls 284, network devices 240, and/or other assets 230 in the network 200 in addition to events generated by one or more operating systems, applications, and/or other suitable sources in the network 200. In one implementation, the log correlation engine 290 may normalize the events contained in the various logs received from the sources distributed across the network 200, and in one implementation, may further aggregate the normalized events with information describing the snapshot of the network 200 obtained by the active scanners 210 and/or the network traffic observed by the passive scanners 220. Accordingly, in one implementation, the log correlation engine 290 may analyze and correlate the events contained in the logs, the information describing the observed network traffic, and/or the information describing the snapshot of the network 200 to automatically detect statistical anomalies, correlate intrusion events or other events with the vulnerabilities and assets in the network 200, search the correlated event data for information meeting certain criteria, or otherwise manage vulnerabilities and assets in the network 200.

Furthermore, in one implementation, the log correlation engine 290 may filter the events contained in the logs, the information describing the observed network traffic, and/or the information describing the snapshot of the network 200 to limit the information that the log correlation engine 290 normalizes, analyzes, and correlates to information relevant to a certain security posture (e.g., rather than processing thousands or millions of events generated across the network 200, which could take a substantial amount of time, the log correlation engine 290 may identify subsets of the events that relate to particular intrusion events, attacker network addresses, assets having vulnerabilities that the intrusion events and/or the attacker network addresses target, etc.). Alternatively (or additionally), the log correlation engine 290 may persistently save the events contained in all of the logs to comply with regulatory requirements providing that all logs must be stored for a certain period of time (e.g., saving the events in all of the logs to comply with the regulatory requirements while only normalizing, analyzing, and correlating the events in a subset of the logs that relate to a certain security posture). As such, the log correlation engine 290 may aggregate, normalize, analyze, and correlate information received in various event logs, snapshots obtained by the active scanners 210 and/or cloud scanners 270, and/or the activity observed by the passive scanners 220 to comprehensively monitor, remediate, and otherwise manage the vulnerabilities and assets in the network 200. Additionally, in one implementation, the log correlation engine 290 may be configured to report information relating to the information received and analyzed therein to the vulnerability management system 250, which may use the information provided by the log correlation engine 290 in combination with the information provided by the passive scanners 220, the active scanners 210, and the cloud scanners 270 to remediate or manage the network 200.

Accordingly, in various embodiments, the active scanners 210 and/or cloud scanners 270 may interrogate any suitable asset 230 in the network 200 to obtain information describing a snapshot of the network 200 at any particular point in time, the passive scanners 220 may continuously or periodically observe traffic traveling in the network 200 to identify vulnerabilities, assets, or other information that further describes the network 200, and the log correlation engine 290 may collect additional information to further identify the vulnerabilities, assets, or other information describing the network 200. The vulnerability management system 250 may therefore provide a unified solution that aggregates vulnerability and asset information obtained by the active scanners 210, the cloud scanners 270, the passive scanners 220, and the log correlation engine 290 to comprehensively manage the network 200.

Security auditing applications typically display security issues (such as vulnerabilities, security misconfigurations, weaknesses, etc.) paired with a particular solution for that given issue. Certain security issues may share a given solution, or have solutions which are superseded or otherwise rendered unnecessary by other reported solutions. Embodiments of the disclosure relate to improving an efficiency by which security issues are reported, managed and/or rectified based on solution supersedence.

In accordance with a first embodiment, when working with security reporting datasets with sparse metadata available, the reported solutions for each security issue are combined, and various “rulesets” are applied against the combined solutions to de-duplicate them and remove solutions that have been superseded by other solutions. As used herein, a ruleset is a set of rules that govern when a solution is to be removed or merged with another and how that merge is to be accomplished. In an example, when solution texts not matching a given ruleset are discovered they are flagged for manual review. Examples of rules that may be included in one or more rulesets are as follows:
If there is more than one matching solution in the solution list, remove all but one of those solutions.
For solutions matching “Upgrade to <product> x.y.z” where x, y, and z are integers, select a single result with the highest x.y.z value (comparing against x first, then y, then z).
For solutions matching “Apply fix <fix> to <product>”, create a new combined solution where <fix> for each solution is concatenated into a comma separated list for a given <product>.

In accordance with a second embodiment, when working with datasets with metadata available that have an identifier that allows grouping of solutions based on product (e.g., common product enumeration (CPE)) and timestamp information on when a fix has become available, the solutions for each group can be filtered with only display the latest “top level” solution for each group being displayed. In an example, the first and second embodiments can be implemented in conjunction with each other to produce a further refined solution set.

As used herein, a “plug-in” contains logic and metadata for an individual security check in a security auditing application. A plugin may check for one or more mitigations/fixes and flag one or more individual security issues. CPE is a standardized protocol of describing and identifying classes of applications, operating systems, and hardware devices present among an enterprise's computing assets. CPE identifiers contain asset type information (OS/Hardware/Application), vendor, product, and can even contain version information. An example CPE string is “cpe:/o:microsoft:windows_vista:6.0:sp1”, where “/o” stands for operating system, Microsoft is the vendor, windows_vista is the product, major version is 6.0, and minor version is SP1. Further, a common vulnerabilities and exposures (CVE) identifier is an identifier from a national database maintained by NIST/Mitre which keeps a list of known vulnerabilities and exposures. An example identifier would be “CVE-2014-6271” which corresponds to the “ShellShock” vulnerability in the database.

In accordance with one implementation of the second embodiment, solutions (or solution ‘texts’) may first together based on the CPEs in the plugins they were reported in. The solutions are then sorted by the patch publication date from the plugins which they were sourced from. Solutions containing text that matches a pattern that indicates that the solution is likely a patch recommendation can all be removed from the group except the solution associated with the most recent patch. In this manner, patches with identifiers that cannot be easily sorted (e.g., patches with non-numerical identifiers) and/or for which no ruleset pertains in accordance with the first embodiment can be filtered out from the solution set. In some implementations, additional ruleset-based filtering from the first embodiment can also be applied, to filter out (or de-duplicate) additional duplicate solution information.

In accordance with a third embodiment, a security auditing application may evaluate further metadata in the solution report results that is added based upon asset-specific information (e.g., such as individual patches installed, which mitigations and patches are missing, what individual software installations are installed, patch supersedence information, the relationship between the mitigations/patches and security issues, etc.).

Web applications can be an essential way to conduct business. Unfortunately, web applications can also be vulnerable to attacks (e.g., denial of service, disclosure of private information, network infiltration, etc.) due to their exposure to public internet. Thus, addressing vulnerabilities before an attacker can exploit them is a high priority. Web application scanning (WAS) can be performed to identify vulnerabilities associated with web applications. For example, a web application scanner (or simply “scanner”) may be used to scan externally accessible website page for vulnerable web applications.

WAS scans may take a relatively long time to perform, and many scans of redundant web pages or substantially redundant web pages may be performed. For example, a newly scanned web page may include only altered content (e.g., text, images, video, etc.) without any functional alterations, making that scan redundant.

When crawling a web application, a large number of web pages are discovered. Hence, deciding which of these web pages to audit via a security audit scan, and which will provide little to no benefit in auditing via the security audit scan, may help to reduce WAS scan times.

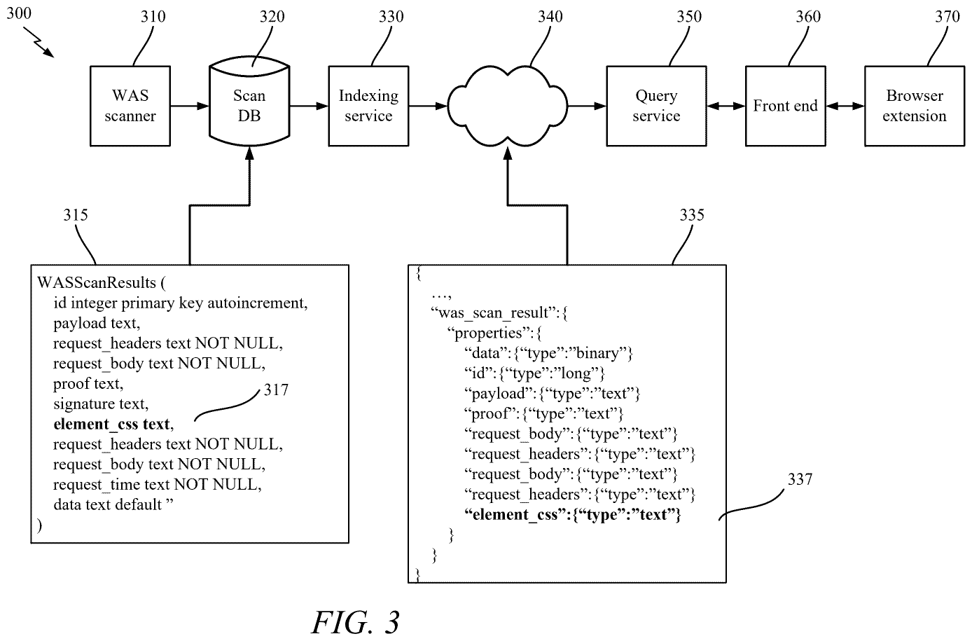

According to various aspects, FIG. 3 illustrates a diagram of an example system 300 suitable for interactive remediation of vulnerabilities of web applications based on scanning of web applications. In particular, as shown in FIG. 3, the system 300 may include a WAS scanner (or simply “scanner”) 310, a scan results 320 (e.g., a database (DB)), a first cloud service 330, a search engine 340, a second cloud service 350, a front end 360, and a browser extension 370. The first and second cloud services 330, 350 may be a same cloud service or different cloud services.

Generally, the scanner 310 may include an element selector for the vulnerable element as a part of its result placed into the scan results 320. Examples (not necessarily exhaustive) of an element selector may include CSS selector, XPath selector, Node number selector, Name selector, Id selector, LinkText selector, and so on. This information may then be passed into the search engine 340 by the first cloud service 330 and included in results from the second cloud service 350 when queried for data about specific vulnerabilities, e.g., from the front end 360. If an element selector exists, the front end 360 (e.g., browser) may include a button that links back to the vulnerable URL and element.

The scanner 310 may be configured to scan web pages to identify one or more vulnerabilities of web applications, i.e., vulnerabilities of elements in web pages. In particular, the scanner 310 may include a selector (not shown) for the vulnerable element in the scan results 320. For example, the selector may implement a scanner function (selector create function) that will take the current element and produce an element selector from it. The URL the element appears on may be included as separate data. A final test may be run before including the data to ensure that the element can be gotten to or otherwise accessible without any extra browser steps that the system is unaware of. Such data may be kept in a table in the scan results 320. For example, FIG. 3 illustrates a VulnerabilitiesDetected table 315, which includes a field for an element selector 317 denoted as “element_css”, which is of text type.

The first cloud service 330 may be configured to index the search results within scan results 320. In particular, the first cloud service 330 may be configured to ensure that the field for the element selector 317 is included when the search engine 340 performs a search. In FIG. 3, it is seen the “was_scan_results” 335 data includes the element selector data 337, which is denoted as “element_css”:{“type”:“text”}.

The second cloud service 350 may be configured to query the search engine 340 for results of WAS scanning, e.g., performed by the scanner 310. In particular, the second cloud service 350 may be configured to query the search engine 340 for the element selector data 337. For example, the second cloud service 350 may submit the following query to pick up the element selector data 337 and return its response, e.g., to the front end 360.
GET/scans/{scanId}/hosts/{hostId}/plugins/{pluginId}

The front end 360 may be configured to receive the WAS scanning results data, including the element selector data for the vulnerable elements. The front end 360 may also be configured to include a button or some other visible element, which when activated (e.g., pressed by a user) will pass message to the browser extension 370 (e.g., chrome extension). The front end 360 may pass at least the following data in the message to the browser extension 370:
URL
Element selector
Plugin ID

The browser extension 370 may be configured to take the message passed from the front end 360, open the URL, and highlight and snap to the vulnerable element. In an aspect, the browser extension 370 may open the URL in a new tab of the browser.

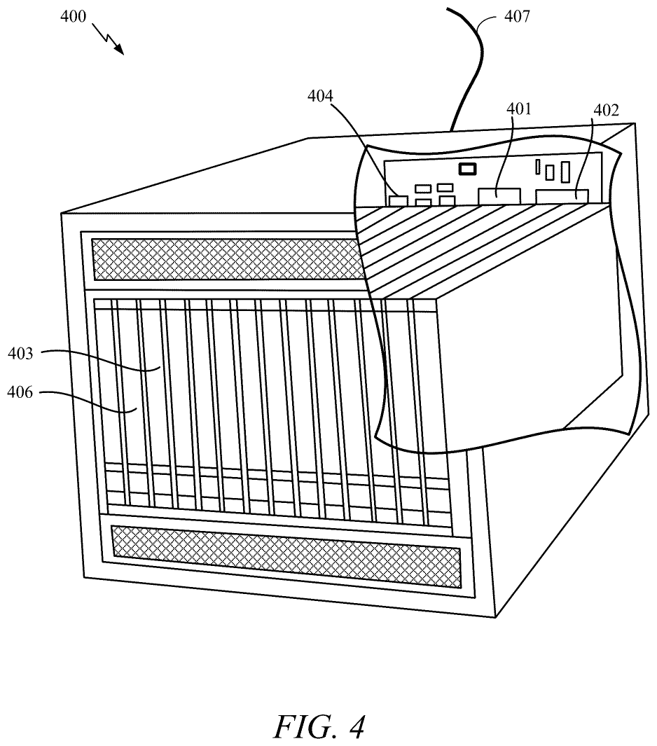

The various embodiments may be implemented on any of a variety of commercially available server devices, such as server 400 illustrated in FIG. 4. In an example, the server 400 may correspond to one example configuration of a server on which a security auditing application may execute, which in certain implementations may be included as part of the vulnerability management system 150 of FIG. 1 or the vulnerability management system 250 of FIG. 2 or WAS scanner 300 of FIG. 3. In FIG. 4, the server 400 includes a processor 401 coupled to volatile memory 402 and a large capacity nonvolatile memory, such as a disk drive 403. The server 400 may also include a floppy disk drive, compact disk (CD) or DVD disk drive 406 coupled to the processor 401. The server 400 may also include network access ports 404 coupled to the processor 401 for establishing data connections with a network 407, such as a local area network coupled to other broadcast system computers and servers or to the Internet.

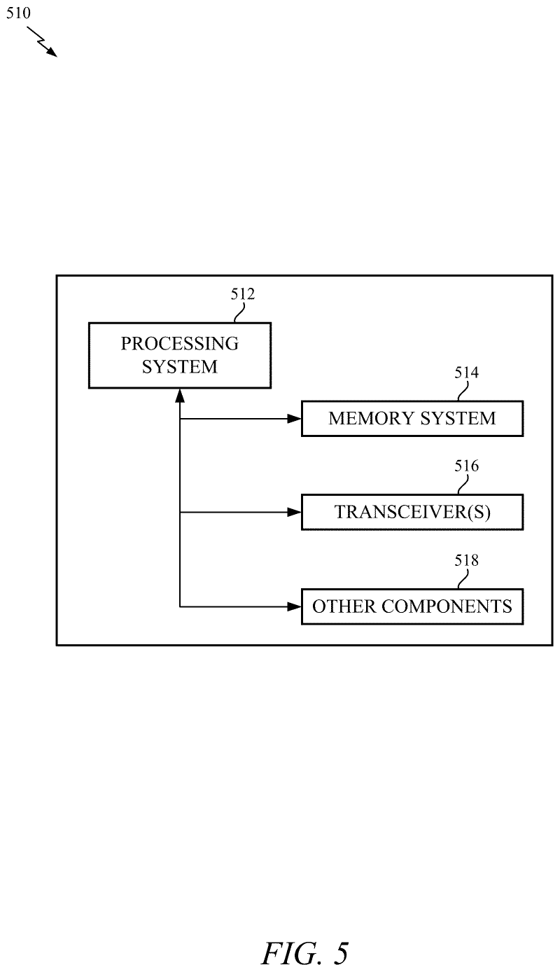

While FIG. 4 illustrates an example whereby a server-type apparatus 400 may implement various processes of the disclosure, in other aspects various aspects of the disclosure may execute on a user equipment (UE), such as UE 510 depicted in FIG. 5.

FIG. 5 generally illustrates a UE 510 in accordance with aspects of the disclosure. In some designs, UE 510 may correspond to any UE-type that is capable of executing the process(es) in accordance with aspects of the disclosure, including but not limited to a mobile phone or tablet computer, a laptop computer, a desktop computer, a wearable device (e.g., smart watch, etc.), and so on. The UE 510 depicted in FIG. 5 includes a processing system 512, a memory system 514, and at least one transceiver 516. The UE 510 may optionally include other components 518 (e.g., a graphics card, various communication ports, etc.).

Machine learning may be used to generate models that may be used to facilitate various aspects associated with processing of data. One specific application of machine learning relates to generation of measurement models for processing of reference signals for positioning (e.g., positioning reference signal (PRS)), such as feature extraction, reporting of reference signal measurements (e.g., selecting which extracted features to report), and so on.

Machine learning models are generally categorized as either supervised or unsupervised. A supervised model may further be sub-categorized as either a regression or classification model. Supervised learning involves learning a function that maps an input to an output based on example input-output pairs. For example, given a training dataset with two variables of age (input) and height (output), a supervised learning model could be generated to predict the height of a person based on their age. In regression models, the output is continuous. One example of a regression model is a linear regression, which simply attempts to find a line that best fits the data. Extensions of linear regression include multiple linear regression (e.g., finding a plane of best fit) and polynomial regression (e.g., finding a curve of best fit).

Another example of a machine learning model is a decision tree model. In a decision tree model, a tree structure is defined with a plurality of nodes. Decisions are used to move from a root node at the top of the decision tree to a leaf node at the bottom of the decision tree (i.e., a node with no further child nodes). Generally, a higher number of nodes in the decision tree model is correlated with higher decision accuracy.

Another example of a machine learning model is a decision forest. Random forests are an ensemble learning technique that builds off of decision trees. Random forests involve creating multiple decision trees using bootstrapped datasets of the original data and randomly selecting a subset of variables at each step of the decision tree. The model then selects the mode of all of the predictions of each decision tree. By relying on a “majority wins” model, the risk of error from an individual tree is reduced.

Another example of a machine learning model is a neural network (NN). A neural network is essentially a network of mathematical equations. Neural networks accept one or more input variables, and by going through a network of equations, result in one or more output variables. Put another way, a neural network takes in a vector of inputs and returns a vector of outputs.

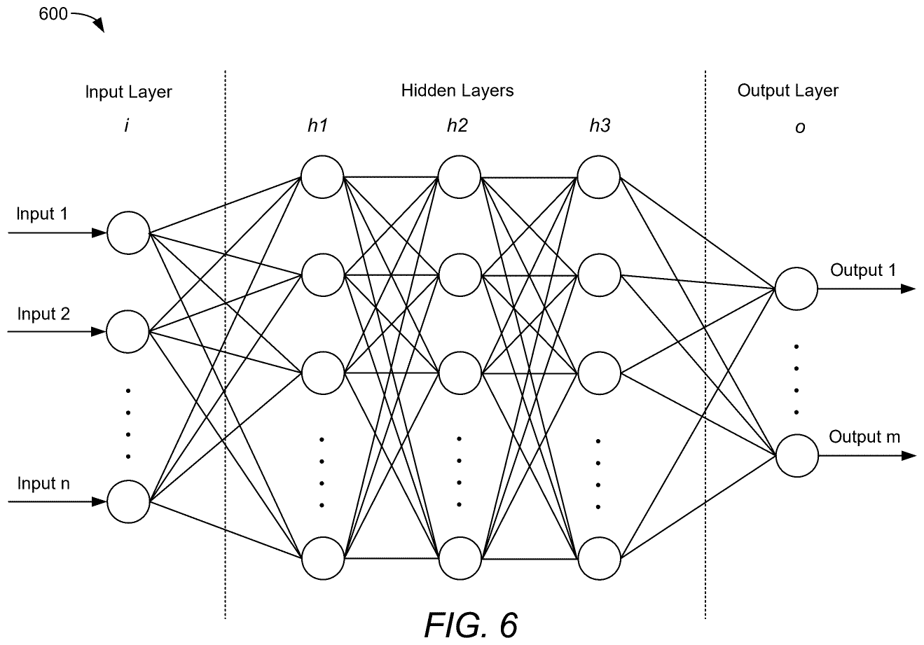

FIG. 6 illustrates an example neural network 600, according to aspects of the disclosure. The neural network 600 includes an input layer ‘i’ that receives ‘n’ (one or more) inputs (illustrated as “Input 1,” “Input 2,” and “Input n”), one or more hidden layers (illustrated as hidden layers ‘h1,’ ‘h2,’ and ‘h3’) for processing the inputs from the input layer, and an output layer ‘o’ that provides ‘m’ (one or more) outputs (labeled “Output 1” and “Output m”). The number of inputs ‘n,’ hidden layers ‘h,’ and outputs ‘m’ may be the same or different. In some designs, the hidden layers ‘h’ may include linear function(s) and/or activation function(s) that the nodes (illustrated as circles) of each successive hidden layer process from the nodes of the previous hidden layer.

In classification models, the output is discrete. One example of a classification model is logistic regression. Logistic regression is similar to linear regression but is used to model the probability of a finite number of outcomes, typically two. In essence, a logistic equation is created in such a way that the output values can only be between ‘0’ and ‘1.’ Another example of a classification model is a support vector machine. For example, for two classes of data, a support vector machine will find a hyperplane or a boundary between the two classes of data that maximizes the margin between the two classes. There are many planes that can separate the two classes, but only one plane can maximize the margin or distance between the classes. Another example of a classification model is Naïve Bayes, which is based on Bayes Theorem. Other examples of classification models include decision tree, random forest, and neural network, similar to the examples described above except that the output is discrete rather than continuous.

Unlike supervised learning, unsupervised learning is used to draw inferences and find patterns from input data without references to labeled outcomes. Two examples of unsupervised learning models include clustering and dimensionality reduction.

Clustering is an unsupervised technique that involves the grouping, or clustering, of data points. Clustering is frequently used for customer segmentation, fraud detection, and document classification. Common clustering techniques include k-means clustering, hierarchical clustering, mean shift clustering, and density-based clustering. Dimensionality reduction is the process of reducing the number of random variables under consideration by obtaining a set of principal variables. In simpler terms, dimensionality reduction is the process of reducing the dimension of a feature set (in even simpler terms, reducing the number of features). Most dimensionality reduction techniques can be categorized as either feature elimination or feature extraction. One example of dimensionality reduction is called principal component analysis (PCA). In the simplest sense, PCA involves project higher dimensional data (e.g., three dimensions) to a smaller space (e.g., two dimensions). This results in a lower dimension of data (e.g., two dimensions instead of three dimensions) while keeping all original variables in the model.

Regardless of which machine learning model is used, at a high-level, a machine learning module (e.g., implemented by a processing system) may be configured to iteratively analyze training input data (e.g., measurements of reference signals to/from various target UEs) and to associate this training input data with an output data set (e.g., a set of possible or likely candidate locations of the various target UEs), thereby enabling later determination of the same output data set when presented with similar input data (e.g., from other target UEs at the same or similar location).

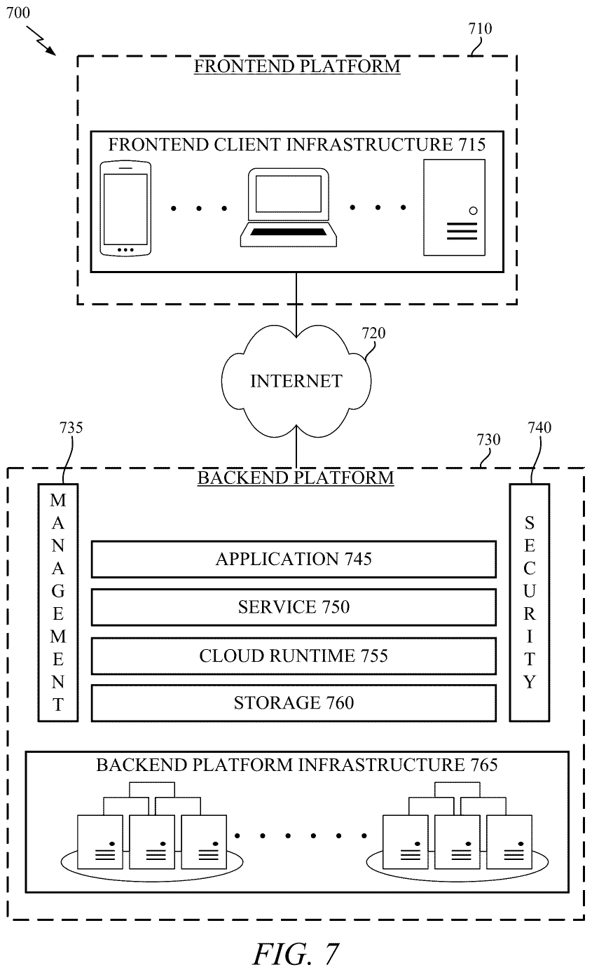

FIG. 7 illustrates cloud network architecture 700, in accordance with aspects of the disclosure. The cloud network architecture 700 comprises a frontend platform 710, an Internet 720, and a backend platform 730. The frontend platform 710 comprises frontend client infrastructure 715, such as smartphones, laptop or desktop computers, and so on, for interfacing with clients (e.g., via web browsers, client applications, etc.). The backend platform 730 comprises a management function 735, a security function 740, an application function 745, a service function 750, a cloud runtime function 755, storage 760 and backend platform infrastructure 765 (e.g., a group of distributed and interconnected computing devices with shareable hardware and/or software resources that support distributed implementation of a set of cloud applications via a respective set of cloud resources).

Referring to FIG. 7, in the cloud network architecture 700, each of the components works together to create a cloud computing platform that provides users with on-demand access to resources and services. The backend platform 730 contains all the cloud computing resources, services 750, data storage 760, and applications 745 offered by a cloud service provider. A network, such as Internet 720, is used to connect the frontend platform 710 and backend cloud architecture components of the backend platform 730, facilitating data to be sent back and forth between them. When users interact with the frontend platform (or client-side interface), the user devices send queries to the backend platform 730 using middleware where the service model carries out the specific task or request.

The types of services available to use vary depending on the cloud-based delivery model or service model you have chosen. In some designs, there are three main cloud computing service models, e.g.:
Infrastructure as a service (IaaS): This model provides on-demand access to cloud infrastructure, such as servers, storage, and networking. This eliminates the need to procure, manage, and maintain on-premises infrastructure.
Platform as a service (PaaS): This model offers a computing platform with all the underlying infrastructure and software tools needed to develop, run, and manage applications.
Software as a service (SaaS): This model offers cloud-based applications that are delivered and maintained by the service provider, eliminating the need for end users to deploy software locally.

In some designs, cloud architecture may also be characterized in terms of cloud architecture layers, e.g.:
Hardware: The servers, storage, network devices, and other hardware that power the cloud.
Virtualization: An abstraction layer that creates a virtual representation of physical computing and storage resources. This allows multiple applications to use the same resources.
Application and service: This layer coordinates and supports requests from the frontend user interface, offering different services based on the cloud service model, from resource allocation to application development tools to web-based applications.

In some designs, various types of cloud architecture may be implemented, e.g.:
Public cloud architecture uses cloud computing resources and physical infrastructure that is owned and operated by a third-party cloud service provider. Public clouds enable you to scale resources easily without having to invest in your own hardware or software, but use multi-tenant architectures that serve other customers at the same time.
Private cloud architecture refers to a dedicated cloud that is owned and managed by your organization. It is privately hosted on-premises in your own data center, providing more control over resources and more security over data and infrastructure. However, this architecture is considerably more expensive and may benefit from more IT expertise to maintain.
Hybrid cloud architecture uses both public and private cloud architecture to deliver a flexible mix of cloud services. A hybrid cloud allows you to migrate workloads between environments, allowing you to use the services that best suit your business demands and the workload. Hybrid cloud architectures are often the solution of choice for businesses that need control over their data but also want to take advantage of public cloud offerings.
Multicloud architecture uses cloud services from multiple cloud providers. Multicloud environments are gaining popularity for their flexibility and ability to better match use cases to specific offerings, regardless of vendor.

In some designs, components of cloud architecture include:
Virtualization: Clouds are built upon the virtualization of servers, storage, and networks. Virtualized resources are a software-based, or virtual, representation of a physical resource such as servers or storage. This abstraction layer facilitates multiple applications to utilize the same physical resources, thereby increasing the efficiency of servers, storage, and networking throughout the enterprise.
Infrastructure: loud infrastructure includes all the components of traditional data centers including servers, persistent storage, and networking gear including routers and switches.
Middleware: As in traditional data centers, these software components such as databases and communications applications enable networked computers, applications, and software to communicate with each other.
Management: These tools enable continuous monitoring of a cloud environment's performance and capacity. IT teams can track usage, deploy new apps, integrate data, and ensure disaster recovery, all from a single console.
Automation software: The delivery of critical IT services through automation and pre-defined policies can significantly ease IT workloads, streamline application delivery, and reduce costs. In cloud architecture, automation is used to easily scale up system resources to accommodate a spike in demand for compute power, deploy applications to meet fluctuating market demands, or ensure governance across a cloud environment.

With the proliferation of vulnerabilities in underlying components and libraries, it is becoming more important to understand the libraries and components an application ships with and their versions. To this end, a Software Bill of Materials (SBOM) is a list of all the components, dependencies, and metadata that make up a software product. SBOMs are similar to nutrition labels on food, listing the ingredients that make up the software.

SBOMs are important for a number of reasons, including:

Security: SBOMs help identify and manage risks in the software supply chain. They can help organizations understand the origin of each component and identify potential vulnerabilities.

Regulatory compliance: SBOMs can help organizations demonstrate transparency and control over the software components used in their applications.

Transparency: SBOMs help organizations make better security decisions based on their knowledge of the software's component parts.

Auditing: SBOMs help ensure that only authorized dependencies are included in a software project.

SBOMs include information such as: Licenses that govern the components, Versions of the components used in the code, Patch status of the components, Open-source and commercial third-party libraries, and API calls. While there is no single definitive standard for SBOMs, SBOMs typically include a description of the supplier of the software, the author of the SBOM, and the tool used to generate the SBOM. In 2021 for example, the United States Department of Commerce released guidelines that define certain minimum elements for SBOMs.

In some designs, an SBOM provides those who produce, purchase, and operate software with information that enhances their understanding of the supply chain, which enables multiple benefits, most notably the potential to track known and newly emerged vulnerabilities and risks. Among these are the use of SBOMs for inventory, vulnerability, and license management by producers and operators, and risk evaluation (license and vulnerability analysis) by purchasers.

SBOMs offer advantages to producers such as ensuring that components are up to date and allowing a quick response to new vulnerabilities. SBOMs also offer benefits beyond security such as supporting greater efficiency and effectiveness through visibility, which in turn enables prioritization and better management. For example, SBOMs assist the producer with knowing and complying with license obligations.

In the use case of vulnerability management, SBOM data helps producers and operators more quickly and accurately assess the risk associated with a newly uncovered vulnerability by providing transparency across dependencies within the software ecosystem. As such, it improves both vulnerability identification and the speed of response.

Understanding the software supply chain, obtaining comprehensive SBOM data across software components, and using it to identify and analyze known vulnerabilities and potential mitigations are crucial in managing risk. This may be realized with machine-readable SBOMs supporting automation and tool integration, and the ability for applications to query and process this data.

In some designs, the minimum elements of an SBOM may include the following, e.g.:

### Minimum Elements of SBOM

TABLE 1
Example of Minimum Elements of SBOM

| | |
|---|---|
| Data Fields | Document baseline information about each component that should |
| | be tracked: Supplier, Component Name, Version of the Component, |
| | Other Unique Identifiers, Dependency Relationship, Author of |
| | SBOM Data, and Timestamp. |
| Automation | Support automation, including via automatic generation and |
| Support | machine-readability to allow for scaling across the software |
| | ecosystem. Data formats used to generate and consume SBOMs |
| | include SPDX, CycloneDX, and SWID tags. |
| Practices and | Define the operations of SBOM requests, generation and use |
| Processes | including: Frequency, Depth, Known Unknowns, Distribution |

In some designs, Data Fields of an SBOM may include the following, e.g.:

TABLE 2
SBOM Data Field Examples

| Data Field | Description |
|---|---|
| Supplier Name | The name of an entity that creates, defines, and identifies |
| | components. |
| Component | Designation assigned to a unit of software defined by the original |
| Name | supplier. |
| Version of the | Identifier used by the supplier to specify a change in software from |
| Component | a previously identified version. |
| Other Unique | Other identifiers that are used to identify a component, or serve as a |
| Identifiers | look-up key for relevant databases. |
| Dependency | Characterizing the relationship that an upstream component X is |
| Relationship | included in software Y. |
| Author of SBOM | The name of the entity that creates the SBOM data for this |
| Data | component. |
| Timestamp | Record of the date and time of the SBOM data assembly. |

In some designs, additional Data Fields of an SBOM may include the following, e.g.:
Hash of the Component. When referring to a piece of software, robust identifiers are important for mapping the existence of a component to relevant sources of data, such as vulnerability data sources. A cryptographic hash may provide a foundational element to assist in this mapping, as well as helping in instances of renaming and whitelisting. Hashes also offer confidence that a specific component was used. The consumer could compare the hash of the component with a known, trusted version. This could help verify that an “approved” version of a component was used, and is necessary to identify whether the component has been altered in unauthorized fashion. In some designs, a hash is a key foundation for using SBOM to have trust in the software supply chain. There are some situations when a hash may not be possible, or convey relatively little value. If component information was obtained from a tool that did not have direct access to the underlying component (e.g. a binary analysis tool), then the component author may not be able to credibly determine the exact bits used, and so be unable to generate a hash. There are benefits of added assurance that come with a hash, but the diversity of the potential targets makes implementation somewhat complex. A file is straightforward, but an executable will have some differences compared to source packages and different hash algorithms will, of course, produce different values. A number of resolutions to this challenge exist, including providing enough detail for the consumer to replicate the hash from the original, or multiple hashes for the small number of potential implementations. Organizations can request hashes for SBOMs today, especially those focused on high assurance use cases. It is recommended that they specify further details about how the hash should be generated. Further defining and refining best practices and specifications for hash generation and consumption should be a priority for the SBOM community.
Lifecycle Phase. The data about software components can be collected at different stages in the software lifecycle, including from the software source, at build time, or after build through a binary analysis tool. Due to unique features of each of these stages, the SBOM may have some differences depending on when and where the data was created. For example, a compiler may pull in a slightly different version of a component than what was expected from the source. For this reason, it would be helpful to have some means of easily conveying where, when, and how the SBOM data was recorded. As noted in the Future of SBOM section below, this may ultimately allow for the documentation of more supply chain data. In the short run, simply noting how this data was captured, (e.g. “source,” “build,” or “post-build”) will be helpful for consumption and data management.
Other Component Relationships. The minimum elements of SBOM are connected through a single type of relationship: dependency. That is, X is included in Y. This relationship is implied in the SBOM graph structure. Other types of dependency relationships can be captured, and have been implemented in some SBOM standards. One approach that can be captured today beyond direct dependencies is “derivation” or “descendancy”. This can indicate that a component is similar to some other known component, but that some changes have been made. It can be useful to track for its shared origins and content. Further suggestions on other types of dependencies are explored below.
License Information. License management was an early use case for SBOM, helping organizations with large and complex software portfolios track the licenses and terms of their diverse software components, especially for open source software. SBOMs can convey data about the licenses for each component. This data can also allow the user or purchaser to know if the software can be used as a component of another application without creating legal risk.

In some designs, Automation Support of an SBOM may include documentation of support for automation, including automatic generation and machine-readability, allows the ability to scale across the software ecosystem, particularly across organizational boundaries. Taking advantage of SBOM data may may benefit from tooling, which may benefit from predictable implementation and data formats. For example, some agencies may want to integrate this capability into their existing vulnerability management practices; others might desire real-time auditing of compliance against security policies.

In some designs with respect to Practices and Processes of an SBOM, an SBOM may be more than a structured set of data; e.g., to integrate the SBOM into the operations of the secure development life cycle an organization may follow certain practices and processes that focus on the mechanics of SBOM use. A number of elements may be explicitly addressed in any policy, contract, or arrangement to ask for or provide SBOMs. Examples of Practices and Processes of an SBOM are as follows, e.g.:
Frequency. If the software component is updated with a new build or release, a new SBOM may be created to reflect the new version of the software. This includes software builds to integrate an updated component or dependency. Similarly, if the supplier learns new details about the underlying components or wishes to correct an error in the existing SBOM data, the supplier may issue a new, revised SBOM.
Depth. An SBOM may contain all primary (top level) components, with all their transitive dependencies listed. At a minimum, all top-level dependencies may be listed with enough detail to seek out the transitive dependencies recursively. Going further into the graph will provide more information. As organizations begin SBOM, depth beyond the primary components may not be easily available due to existing requirements with sub-component suppliers. Eventual adoption of SBOM processes will enable access to additional depth through deeper levels of transparency at the sub-component level. It should be noted that some use cases may benefit from complete or mostly complete graphs, such as the ability to “prove the negative” that a given component is not on an organization's network. An SBOM consumer can specify depth by number of transitive stages. Alternatively, the SBOM consumer could specify depth in operational terms. This could include software attributes, such as “all non-open source software,” or all components of a certain function or complexity. Organizations can also incentivize greater reporting depth and completeness by offering different requirements on reporting and remediation of vulnerabilities in components enumerated in the SBOM versus those that are not. Such specifications are outside the scope of these minimum elements.
Known Unknowns. For instances in which the full dependency graph is not enumerated in the SBOM, the SBOM author may explicitly identify “known unknowns.” That is, the dependency data draws a clear distinction between a component that has no further dependencies, and a component for which the presence of dependencies is unknown and incomplete. This may be integrated into the automated data. To avoid erroneous assumptions, the default interpretation of the data may be that the data is incomplete; the author of the data may affirmatively state when the direct dependencies of a component have been fully enumerated, or when a component has no further dependencies. Today, this is implemented in the dependency relationship data field.
Distribution and Delivery. SBOMs may be available in a timely fashion to those who need them and have appropriate access permissions and roles in place. The SBOM data can accompany each instance of the software, or merely be accessible and directly mappable to the specific version of the software in question (e.g. through a version-specific URL). Sharing SBOM data down the software supply chain can be thought of as comprising two parts: how the existence and availability of the SBOM is made known (advertisement or discovery) and how the SBOM is retrieved by, or transmitted to, those who have the appropriate permissions (access). Similar to other areas of software assurance, there will not be a one-size-fits-all approach. Anyone offering SBOMs may have some means to make them available and support ingestion, but this can ride on existing mechanisms. SBOM delivery can reflect the nature of the software as well: executables that live on endpoints can
Access Control. Many suppliers, including open source maintainers and those with widely available software, may feel their interests are best served by making SBOM data public. Other organizations, especially at first, may wish to keep this data confidential, and limit access to specific customers or users. If access control is desired, the terms may be specified, including specific allowances and accommodations for integrating SBOM data into the user's security tools. Such specification can be determined through licensing, contracts, or other existing mechanism used to circumscribe the use and rights around the software itself. Given the variation in software licensing and contracts, the nature of this specification is outside the scope of this document.
Accommodation of Mistakes. A final practice area, accommodation of mistakes, may be built into the initial implementation phase of SBOM, allowing for omissions and errors. As many commentators have observed, while internal management of supply chain data may be a best practice, it is still evolving. The Administration has identified SBOM as a priority to drive software assurance and supply chain risk management, and starting today is better than waiting for perfection. In light of the absence of perfection, consumers of SBOMs may be explicitly tolerant of the occasional incidental error. This will facilitate constant improvement of tools: suppliers may offer updated data as they come across issues with past SBOMs, and consumers may encourage these updates by welcoming supplements and corrections without penalty when offered in good faith. As stated above regarding frequency, when new data is known an updated SBOM may be issued. Notably, this tolerance may not apply to intentional obfuscation or willful ignorance.

Many modern software applications are provided as a service. This affords both distinctions and unique challenges with respect to SBOM data. Since the software is not running on the customer's infrastructure or under their control, the risk management roles are different. The user is not responsible for maintenance, nor can they control any environmental factors. The responsibilities for understanding and acting on vulnerability or risk information lies with the service provider. Moreover, modern web applications often have much faster release and update cycles, making direct provisioning of SBOM data less practical.

At the same time, there are challenges to capturing the software supply chain risks in the cloud context. In some cases, the service provider must not only track metadata from the software supply chain of the software they are responsible for producing, but in the infrastructure stack that supports the application, whether under the direct control of the provider or from some external service provider. Many applications also take advantage of third-party services, sending data and requests to other organizations through application programming interfaces. Capturing meaningful metadata about the full application stack and third-party services may be helpful, but is not yet standardized or sufficiently mature for cross-organization implementation.

In some designs, the following SBOM terminology may be used:
Authenticity: The property that data originated from its purported source.
Author: An entity that creates an SBOM. When author and supplier are different, this indicates that one entity (the author) is making claims about components created or included by a different entity (the supplier).
Component or “software” component: A unit of software defined by a supplier at the time the component is built, packaged, or delivered. Many components contain sub-components. Examples of components include a software product, a device, a library, or a single file.
Consumer: Entity that obtains SBOMs. An entity can be both a supplier and consumer, using components with SBOM data in its own software, which is then passed downstream. An “end-user” consumer (that is not also a supplier) may also be called an operator or a leaf entity. The “consumer” may also correspond to any entity that utilizes the SBOM in some manner, such as a vulnerability management system.
Dependency: Characterizing the relationship that an upstream component X is included in software Y.
Downstream: Referring to how a component is subsequently used in other pieces of software at a later stage in the supply chain.
Integrity: Guarding against improper information modification or destruction.
Lifecycle Phase: The stage in the software lifecycle where an SBOM is generated (e.g. from source, at the time of build or packaging, or from a built executable).
Open-source software: Software that can be accessed, used, modified, and shared by anyone.
Pedigree: Data on the origins of components that have come together to make a piece of software and the process under which they came together. This could include data beyond the minimum elements, such as compiler details and settings.32
Provenance: Data about the chain of custody of the software and all of the constituent components, potentially including data about the authors and locations from where the components were obtained.
SBOM (Software Bill of Materials): A formal record containing the details and supply chain relationships of various components used in building software. Software developers and vendors often create products by assembling existing open source and commercial software components. The SBOM enumerates these components in a product.
Software-as-a-Service: The capability provided to the consumer to use the provider's applications running on a cloud infrastructure. The applications are accessible from various client devices through either a thin client interface, such as a web browser (e.g., web-based email), or a program interface. The consumer does not manage or control the underlying cloud infrastructure including network, servers, operating systems, storage, or even individual application capabilities, with the possible exception of limited user-specific application configuration settings.
Sub-component: Constituent part(s) of a component.
Supplier: An entity that creates, defines, and identifies components and produces associated SBOMs. A supplier may also be known as a manufacturer, vendor, developer, integrator, maintainer, or provider. Ideally, all suppliers are also authors of SBOMs for the suppliers' components. Most suppliers are also consumers. A supplier with no included upstream components is a root entity.
Transitive Dependency: Characterizing the relationship that if an upstream component X is included in software Y and component Z is included in component X then component Z is included in software Y.
Upstream: Referring to the origins of components or sub-components, at an earlier stage in the supply chain.

Tools exist for use by a developer (vendor or supplier) for generation of SBOMs before release (or deployment) of the software product. However, in practice, there is no enforcement mechanism for SBOMs, and many software products are released without SBOMs. Tools do not currently exist for generation of SBOMs after release (or deployment) of the software product when that software product is deployed or installed onto runtime systems that are configured to execute the software product.

Aspects of the disclosure are directed to a “runtime” software bill of materials (SBOM) (e.g., a SBOM for software component(s) configured for execution on an end-device). In an aspect, the runtime SBOM includes common-path rood nodes corresponding to software component(s). In an aspect, each common-path rood node is further associated with dependent node(s) corresponding to software sub-component(s). Such aspects may provide various technical advantages, such as improved vulnerability tracking, particularly for software component(s) that are released by developer(s) without a developer-generated SBOM.

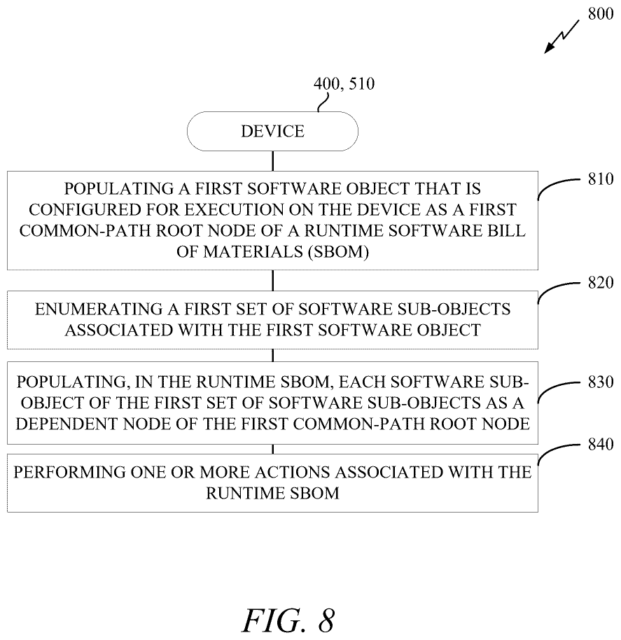

FIG. 8 illustrates a process 800, in accordance with aspects of the disclosure. The process 800 of FIG. 8 may be performed by a device, such as a server 400 or a UE 510.

Referring to FIG. 8, at 810, the device (e.g., processor 401, memory 402 or disk drive 403 or 406, processing system 512, memory system 514, etc.) populates a first software component that is configured for execution on the device as a first common-path root node of a runtime software bill of materials (SBOM).

Referring to FIG. 8, at 820, the device (e.g., processor 401, memory 402 or disk drive 403 or 406, processing system 512, memory system 514, etc.) enumerates a first set of software sub-components associated with the first software component.

Referring to FIG. 8, at 830, the device (e.g., processor 401, memory 402 or disk drive 403 or 406, processing system 512, memory system 514, etc.) populates, in the runtime SBOM, each software sub-component of the first set of software sub-components as a dependent node of the first common-path root node.

Referring to FIG. 8, at 840, the device (e.g., processor 401, memory 402 or disk drive 403 or 406, access ports 404, processing system 512, memory system 514, transceiver(s) 516, etc.) performs one or more actions associated with the runtime SBOM.

Referring to FIGS. 8, in some designs, the first software component corresponds to an application, a library or a component.

Referring to FIGS. 8, in some designs, the first set of software sub-components comprises at least one application, at least one library, at least one component or any combination thereof.

Referring to FIGS. 8, in some designs, the enumerating is performed based on indexing of file system substrings associated with the first software component.

Referring to FIGS. 8, in some designs, the first software component corresponds to a software sub-component of another software component.

Referring to FIGS. 8, in some designs, the device further populates a second software component that is configured for execution on the device as a second common-path root node of the runtime SBOM, enumerates a second set of software sub-components associated with the second software component, and populates, in the runtime SBOM, each software sub-component of the second set of software sub-components as a dependent node of the second common-path root node.

Referring to FIGS. 8, in some designs, the device further enumerates a set of software components comprising the first software component and at least one other software component. In an aspect, each software component in the set of software components is populated of the runtime SBOM as a respective common-path rood node. In an aspect, the device further generates a data structure that sorts the set of software components by file system path length. In an aspect, an order in which each software component in the set of software components is populated in the runtime SBOM is based on the data structure. In an aspect, the order is from a shortest file system path length to a longest file system path length.

Referring to FIGS. 8, in some designs, the one or more actions comprise reporting the runtime SBOM to a vulnerability management system.

Referring to FIGS. 8, in a specific example, a runtime SBOM need not be limited to an SBOM format utilized by certain developers with respect to pre-release versions of a software component. For example, some features of a runtime SBOM may utilize (or incorporate) information that is not readily available to such developers. For example, after a software component is deployed on a device, the device may identify anomalies associated with the software component that would not be apparent from a static vendor supplied SBOM. For example, if a binary was replaced on device, then the runtime SBOM would be able to detect the binary replacement when compared against a vendor-supplied SBOM. Hence, runtime SBOMs may provide advantages even in scenarios where vendor-supplied SBOMs are available.

Referring to FIG. 8, in a specific example, a set of enumerated software components (e.g., applications, libraries, etc.) installed on a running system are evaluated to create an inventory of software is on the system. The inventory is then iterated to identify the longest common path and group those together into a hierarchy. By matching current paths to previously evaluated paths, it can be determined whether a software object component is installed as a sub-component of a higher level software component. Once this hierarchical model is established, this data as well as previously enumerated software attributes are used to create a SBOM.

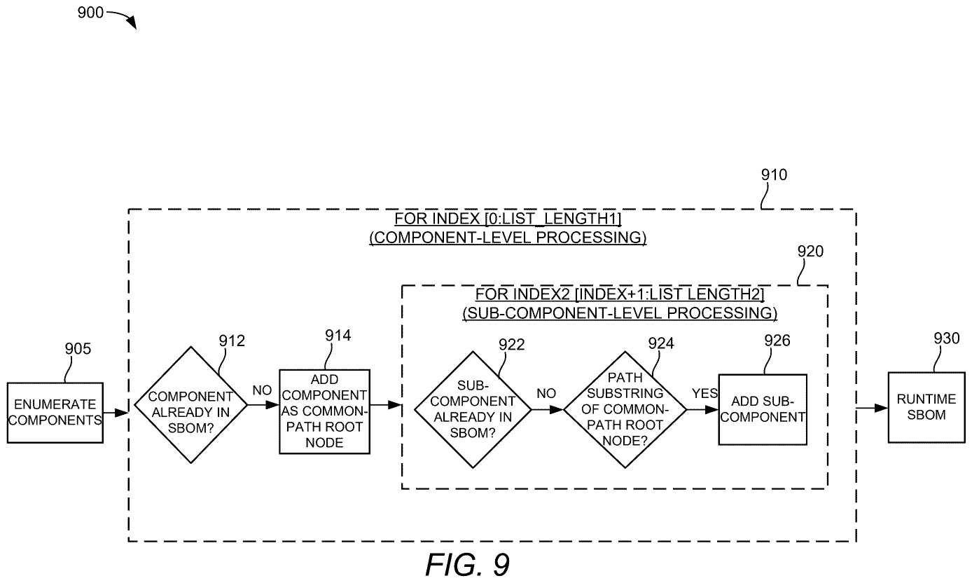

FIG. 9 illustrates an example implementation 900, in accordance with aspects of the disclosure.

Referring to FIG. 9, at 905, software component(s) of a device are enumerated. The enumerated software component(s) may include installed applications, libraries, and so on. The number of the numerated software component(s) is denoted as LIST_LENGTH1. In some designs, the enumerated software component(s) are organized in a data structure by path length for faster sorting. In some designs, the list of paths are arranged in order from smallest to largest into a flattened array.

The enumerated software component(s) are provided to a for loop 910, which executes at the component-level. For example, the for loop 910 starts with an INDEX=0, and INDEX is incremented at each loop by one until LIST_LENGTH1 is reached. A different enumerated software component is evaluated at each iteration of the for loop 910, so that each of the enumerated software component(s) is evaluated.

Referring to FIG. 9, at 912, the device determines whether the software component being evaluated is already populated in an SBOM as a common-path root node. If so, this iteration of the for loop 910 is terminated, INDEX is incremented by 1, and the process returns to 912 for the next iteration of the for loop 910. If not, the software component being evaluated is added as a common-path root node, and the software component is then evaluated at the sub-component-level by for loop 920. For example, the for loop 920 starts with an INDEX2=INDEX+1, and INDEX2 is incremented at each loop by one until LIST_LENGTH2 is reached. Here, LIST_LENGTH2 denotes the number of numerated sub-components for the software component under evaluation. A different enumerated sub-component is evaluated at each iteration of the for loop 920, so that each of the enumerated software sub-component(s) is evaluated.

Referring to FIG. 9, at 922, the device determines whether the sub-component being evaluated is already populated in an SBOM as a dependent node to the common-path root node of the software component under evaluation. If so, this iteration of the for loop 920 is terminated, INDEX2 is incremented by 1, and the process returns to 922 for the next iteration of the for loop 920. If not, at 924, the device determines whether the sub-component is associated with a path substring of the common-path root node. If not, this iteration of the for loop 920 is terminated, INDEX2 is incremented by 1, and the process returns to 922 for the next iteration of the for loop 920. If so, at 926, the SBOM is populated with the sub-component as a dependent node of the common-path root node of the subject component under evaluation. At this point, INDEX2 is incremented by 1, and the process either returns to 922 for the next iteration of the for loop 920 or (if INDEX2 has reached LIST_LENGTH2) to 912 for the next iteration of the for loop 910.

Referring to FIG. 9, once the for loops 910 and 920 are completed, the runtime SBOM is complete at 930.

Referring to FIG. 9, as an example with respect to the path substring sub-component-level analysis of the for loop 920, if a common-path root node is at/opt/nessus/and openssl is at/opt/nessus/lib/libssl.so, then the root node filesystem path of/opt/nessus is a substring of the openssl filesystem path, and openssl is a sub-component of the common-path root node at/opt/nessus.

Below, examples of SBOM inventory items are provided based on an example implementation of the process 900 of FIG. 9, e.g.:

```
{
  “version”: 1,
  “metadata”: {
    “tools”: {
      “name”: “Nessus SBOM Plugin”,
      “vendor”: “Tenable”
    },
    “component”: {
      “version”: “14.3.558.0000”,
      “cpe”:
“cpe:2.3:a:symantec:endpoint_protection_manager:14.3.558.0000:*:any:*:*:*:*:*”,
      “type”: “application”,
      “name”: “Symantec Endpoint Protection Manager”,
      “properties”: {
        “name”: “path”,
        “value”: “C:\\Program Files (x86)\\Symantec\\Symantec Endpoint Protection
Manager\\”
      }
    }
  },
  “specVersion”: “1.4”,
  “bomFormat”: “CycloneDX”,
  “components”: [
    {
      “version”: “1.11.0.6.8-LTS”,
      “cpe”: “cpe:2.3:a:oracle:jre:1.11.0.6.8-lts:*:any:*:*:*:*:*”,
      “type”: “application”,
      “name”: “Java Runtime”,
      “properties”: {
        “name”: “path”,
        “value”: “C:\\Program Files (x86)\\Symantec\\Symantec Endpoint Protection
Manager\\jre11\\”
      }
    },
    {
      “version”: “1.11.0.6.8-LTS”,
      “cpe”: “cpe:2.3:a:oracle:jre:1.11.0.6.8-lts:*:any:*:*:*:*:*”,
      “type”: “application”,
      “name”: “Java”,
      “properties”: {
        “name”: “path”,
        “value”: “C:\\Program Files (x86)\Symantec\\Symantec Endpoint Protection
Manager\\jre11\\”
      }
    },
    {
      “version”: “2.4.39.657”,
      “cpe”: “cpe:2.3:a:apache:http_server:2.4.39.657:*:any:*:*:*:*:*”,
      “type”: “application”,
      “name”: “Apache”,
      “properties”: {
        “name”: “path”,
        “value”: “C:\\Program Files (x86)\\Symantec\\Symantec Endpoint Protection
Manager\\apache\\bin\\httpd.exe”
      }
    },
    {
      “version”: “2.1.2”,
      “group”: null,
      “type”: “library”,
      “name”: “springfox-spi”,
      “hashes”: [
        {
          “content”: “91C7418CBFFCD332FF2AAB27799F6CEC”,
          “alg”: “MD5”
        },
        {
          “content”:
“83B9E241DC646E195E7FEA13CC02834EC58C32B85D0FA9521E8ADFB0140DC
D2D”,
          “alg”: “SHA256”
        },
        {
          “content”:
“7328535B3B3AE5F1633F3924A1FCE3FE4C5DAEA6AE0F79403BED509322900FF
5873CCC38C113865C83C84333AF1D4B36A57B9181DDA943ABDE722E78F25AF7
33”,
          “alg”: “SHA512”
        }
      ],
      “mime-type”: “application/java-archive”,
      “properties”: [
        {
          “name”: “path”,
          “value”: “C:\\Program Files (x86)\\Symantec\\Symantec Endpoint Protection
Manager\\tomcat\\instances\\sepm-api\\webapps\\sepm\\WEB-INF\\lib\\springfox-spi-
2.1.2.jar”
        }
      ]
    },
    {
      “version”: “1.0.0.Beta4”,
      “group”: “org.mapstruct”,
      “type”: “library”,
      “name”: “mapstruct”,
      “hashes”: [
        {
          “content”: “C16F2D0C1604EF9B49B36E538A90854D”,
          “alg”: “MD5”
        },
        {
          “content”:
“CE8D9F6032623BCBCF5DB6C8B2E865D3EB92399ED6C3F3D8795611B6139140
9D”,
          “alg”: “SHA256”
        },
        {
          “content”:
“A78D38FCB57C5C8E4165F5323D3BC91287774A3CB2D1B5F810AB4EBC9CE6F
AAB4BFE2C80BF1BCDFC410EDF636CC3FA653F4472747A7450399F5864C49D4
D9C69”,
          “alg”: “SHA512”
        }
      ],
      “mime-type”: “application/java-archive”,
      “properties”: [
        {
          “name”: “path”,
          “value”: “C:\\Program Files (x86)\\Symantec\\Symantec Endpoint Protection
Manager\\tomcat\\instances\\sepm-api\\webapps\\sepm\\WEB-INF\\lib\\mapstruct-
1.0.0.Beta4.jar”
        }
      ]
    },
    {
      “version”: “4.2.2 (b0)”,
      “group”: null,
      “type”: “library”,
      “name”: “com.sun.jna”,
      “hashes”: [
        {
          “content”: “78EB97E642452EB30AEA5F76E52A7603”,
          “alg”: “MD5”
        },
        {
          “content”:
“1F38AF54E06C6E6F6DBF39BA2C052B952DEA5DDDB4871127B34639DDEB11B
DBE”,
          “alg”: “SHA256”
        },
        {
          “content”:
“E2594C5D95937A8675190750E29B73C10F496637E940B4444DD4A6F03F7F323A
346481521881A6D54A826FD12DF312BB21B1F07EDCFA3A09141F8CF362F6A564
”,
          “alg”: “SHA512”
        }
      ],
      “mime-type”: “application/java-archive”,
      “properties”: [
        {
          “name”: “path”,
          “value”: “C:\\Program Files (x86)\\Symantec\\Symantec Endpoint Protection
Manager\\tomcat\\lib\\jna-4.2.2.jar”
        }
      ]
    },
    {
      “version”: “1.3.2.RELEASE”,
      “group”: “org.springframework.data”,
      “type”: “library”,
      “name”: “spring-data-commons-core”,
      “hashes”: [
        {
          “content”: “24FCE56E0D0681F7DB449394FC00F362”,
          “alg”: “MD5”
        },
        {
          “content”:
“58B878BCD8A1E524C8163AB7ACDC4AF1E29CEBB5DF53C9806AE679D53445E
8DF”,
          “alg”: “SHA256”
        },
        {
          “content”:
“64945FD7B97CC9C19442A88F3C4A33F2DC3171B102979091BD13854871C87DE
D77B6A22F27BBFD842DD51404C464EAC34BBB8AE892BB12342F68E302B48DD
F9F”,
          “alg”: “SHA512”
        }
      ],
      “mime-type”: “application/java-archive”,
      “properties”: [
        {
          “name”: “path”,
          “value”: “C:\\Program Files (x86)\\Symantec\\Symantec Endpoint Protection
Manager\\tomcat\\instances\\sepm-api\\webapps\\sepm\\WEB-INF\\lib\\spring-data-
commons-core-1.3.2.RELEASE.jar”
        }
      ]
    },
    {
      “version”: “2.5”,
      “group”: “commons-lang”,
      “type”: “library”,
      “name”: “commons-lang”,
      “hashes”: [
        {
          “content”: “AB04C560CAEA60D3B0050BEB57776A32”,
          “alg”: “MD5”
        },
        {
          “content”:
“A64E0C73988FEF8D5B73FC29D105A3A6E2DC5D9B90A94FCA065CD2439DC56
590”,
          “alg”: “SHA256”
        },
        {
          “content”:
“EFF388ECCE06DF2D557B63559DB2A6B8932F3466E1015B15653C7F788C77B8B
B8E42DF7DC4FE93077C96CC40942387D38B8110E00400A7594D9395CF0EC7334
D”,
          “alg”: “SHA512”
        }
      ],
      “mime-type”: “application/java-archive”,
      “properties”: [
        {
          “name”: “path”,
          “value”: “C:\\Program Files (x86)\\Symantec\\Symantec Endpoint Protection
Manager\\tomcat\\instances\\sepm-api\\webapps\\sepm\\WEB-INF\\lib\\commons-lang-
2.5.jar”
        }
      ]
    },
    {
      “version”: “6.2”,
      “group”: “com.rsa”,
      “type”: “library”,
      “name”: “SSL-J”,
      “hashes”: [
        {
          “content”: “C6BA8CDFF4C048C80516F35F38104D23”,
          “alg”: “MD5”
        },
        {
          “content”:
“C71BC4E52B6AD5CE6ADA46A0D448D6A22942A473DC46553EC00E265653A24
07D”,
          “alg”: “SHA256”
        },
        {
          “content”:
“163E5922C4358DD47199316C1374314895B6BB25CE2854C6B91780846990356EA
A41522FD52BA76134FF3F9C5C41FC24AA52E7D744C9B1D89FE2F5112D146E88”
,
          “alg”: “SHA512”
        }
      ],
      “mime-type”: “application/java-archive”,
      “properties”: [
        {
          “name”: “path”,
          “value”: “C:\\Program Files (x86)\\Symantec\\Symantec Endpoint Protection
Manager\\bin\\fips17\\sslj.jar”
        }
      ]
    },
    {
      “version”: “4.3.26.RELEASE”,
      “group”: null,
      “type”: “library”,
      “name”: “spring-web”,
      “hashes”: [
        {
          “content”: “9D556CED11008277E89BF1A8C4AC8686”,
          “alg”: “MD5”
        },
        {
          “content”:
“8E37C8C6063C6436A582E344904CC5302D7B5459EA6C050AFB04DE88CA2039E
3”,
          “alg”: “SHA256”
        },
        {
          “content”:
“0C86A4BAA49D9410F4229BE74ECB8037935AA6FBA0D5771EB484D66C52708E
D3CF044E6C82586FFFA0CE6CD468F0B91EF44DCE01B3B011541ECDF23C9507F
3E9”,
          “alg”: “SHA512”
        }
      ],
      “mime-type”: “application/java-archive”,
      “properties”: [
        {
          “name”: “path”,
          “value”: “C:\\Program Files (x86)\\Symantec\\Symantec Endpoint Protection
Manager\\tomcat\\instances\\sepm-api\\webapps\\sepm\\WEB-INF\\lib\\spring-web-
4.3.26.RELEASE.jar”
        }
      ]
    },
    {
      “version”: “1.8”,
      “group”: “org.apache.commons”,
      “type”: “library”,
      “name”: “commons-compress”,
      “hashes”: [
        {
          “content”: “A4D142083F33D7232F1659D7ED4538AE”,
          “alg”: “MD5”
        },
        {
          “content”:
“D33AD0EF520C34BC020CD74F10C0875BB3B5328BE5EDE87B786200F9A4423B
66”,
          “alg”: “SHA256”
        },
        {
          “content”:
“2484274EBED559A38BE9A38629C7041C638EF33281F295861255859352974C585
C18B2A0C35A7E8BD6470E76C91FAC6D42223285FF101240E067AC4789B034C7”
,
          “alg”: “SHA512”
        }
      ],
      “mime-type”: “application/java-archive”,
      “properties”: [
        {
          “name”: “path”,
          “value”: “C:\\Program Files (x86)\\Symantec\\Symantec Endpoint Protection
Manager\\tomcat\\lib\\commons-compress-1.8.jar”
        }
      ]
    },
    {
      “version”: “1.8”,
      “group”: “commons-codec”,
      “type”: “library”,
      “name”: “commons-codec”,
      “hashes”: [
        {
          “content”: “B87AA66FE75685C82D082E750AB51B2E”,
          “alg”: “MD5”
        },
        {
          “content”:
“599B40B94B4A39C2550A4B5106DF071AA03199B71AD5423207E2E7356AA4F8B
B”,
          “alg”: “SHA256”
        },
        {
          “content”:
“FB43D6184495BD21FC70E3C847D06183DEED3E9CEFCB28A4442DAB51CAC58
C52C86F33117B23C589BD97C65C157632F5A96071E9F87EAAE0C6C205E3D6E69
1E3”,
          “alg”: “SHA512”
        }
      ],
      “mime-type”: “application/java-archive”,
      “properties”: [
        {
          “name”: “path”,
          “value”: “C:\\Program Files (x86)\\Symantec\\Symantec Endpoint Protection
Manager\\tomcat\\instances\\sepm-api\\webapps\\sepm\\WEB-INF\\lib\\commons-
codec-1.8.jar”
        }
      ]
    },
    {
```

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A method performed by a device, comprising: populating a first software component that is configured for execution on the device as a first common-path root node of a runtime software bill of materials (SBOM); enumerating a first set of software sub-components associated with the first software component; populating, in the runtime SBOM, each software sub-component of the first set of software sub-components as a dependent node of the first common-path root node; and performing one or more actions associated with the runtime SBOM.

Clause 2. The method of clause 1, wherein the first software component corresponds to an application, a library or a component.

Clause 3. The method of any of clauses 1 to 2, wherein the first set of software sub-components comprises at least one application, at least one library, at least one component or any combination thereof.

Clause 4. The method of any of clauses 1 to 3, wherein the enumerating is performed based on indexing of file system substrings associated with the first software component.

Clause 5. The method of any of clauses 1 to 4, wherein the first software component corresponds to a software sub-component of another software component.

Clause 6. The method of any of clauses 1 to 5, further comprising: populating a second software component that is configured for execution on the device as a second common-path root node of the runtime SBOM; enumerating a second set of software sub-components associated with the second software component; and populating, in the runtime SBOM, each software sub-component of the second set of software sub-components as a dependent node of the second common-path root node.

Clause 7. The method of any of clauses 1 to 6, further comprising: enumerating a set of software components comprising the first software component and at least one other software component, wherein each software component in the set of software components is populated of the runtime SBOM as a respective common-path rood node.

Clause 8. The method of clause 7, further comprising: generating a data structure that sorts the set of software components by file system path length, wherein an order in which each software component in the set of software components is populated in the runtime SBOM is based on the data structure.

Clause 9. The method of clause 8, wherein the order is from a shortest file system path length to a longest file system path length.

Clause 10. The method of any of clauses 1 to 9, wherein the one or more actions comprise reporting the runtime SBOM to a vulnerability management system.

Clause 11. A device, comprising: one or more memories; one or more transceivers; and one or more processors communicatively coupled to the one or more memories and the one or more transceivers, wherein the one or more processors, either alone or in combination, are configured to: populate a first software component that is configured for execution on the device as a first common-path root node of a runtime software bill of materials (SBOM); enumerate a first set of software sub-components associated with the first software component; populate in the runtime SBOM, each software sub-component of the first set of software sub-components as a dependent node of the first common-path root node; and perform one or more actions associated with the runtime SBOM.

Clause 12. The device of clause 11, wherein the first software component corresponds to an application, a library or a component.

Clause 13. The device of any of clauses 11 to 12, wherein the first set of software sub-components comprises at least one application, at least one library, at least one component or any combination thereof.

Clause 14. The device of any of clauses 11 to 13, wherein the enumerating is performed based on indexing of file system substrings associated with the first software component.

Clause 15. The device of any of clauses 11 to 14, wherein the first software component corresponds to a software sub-component of another software component.

Clause 16. The device of any of clauses 11 to 15, wherein the one or more processors, either alone or in combination, are further configured to: populate a second software component that is configured for execution on the device as a second common-path root node of the runtime SBOM; enumerate a second set of software sub-components associated with the second software component; and populate in the runtime SBOM, each software sub-component of the second set of software sub-components as a dependent node of the second common-path root node.

Clause 17. The device of any of clauses 11 to 16, wherein the one or more processors, either alone or in combination, are further configured to: enumerate a set of software components comprising the first software component and at least one other software component, wherein each software component in the set of software components is populated of the runtime SBOM as a respective common-path rood node.

Clause 18. The device of clause 17, wherein the one or more processors, either alone or in combination, are further configured to: generate a data structure that sorts the set of software components by file system path length, wherein an order in which each software component in the set of software components is populated in the runtime SBOM is based on the data structure.

Clause 19. The device of clause 18, wherein the order is from a shortest file system path length to a longest file system path length.

Clause 20. The device of any of clauses 11 to 19, wherein the one or more actions comprise reporting the runtime SBOM to a vulnerability management system.

Clause 21. A device, comprising: means for populating a first software component that is configured for execution on the device as a first common-path root node of a runtime software bill of materials (SBOM); means for enumerating a first set of software sub-components associated with the first software component; means for populating, in the runtime SBOM, each software sub-component of the first set of software sub-components as a dependent node of the first common-path root node; and means for performing one or more actions associated with the runtime SBOM.

Clause 22. The device of clause 21, wherein the first software component corresponds to an application, a library or a component.

Clause 23. The device of any of clauses 21 to 22, wherein the first set of software sub-components comprises at least one application, at least one library, at least one component or any combination thereof.

Clause 24. The device of any of clauses 21 to 23, wherein the enumerating is performed based on indexing of file system substrings associated with the first software component.

Clause 25. The device of any of clauses 21 to 24, wherein the first software component corresponds to a software sub-component of another software component.

Clause 26. The device of any of clauses 21 to 25, further comprising: means for populating a second software component that is configured for execution on the device as a second common-path root node of the runtime SBOM; means for enumerating a second set of software sub-components associated with the second software component; and means for populating, in the runtime SBOM, each software sub-component of the second set of software sub-components as a dependent node of the second common-path root node.

Clause 27. The device of any of clauses 21 to 26, further comprising: means for enumerating a set of software components comprising the first software component and at least one other software component, wherein each software component in the set of software components is populated of the runtime SBOM as a respective common-path rood node.

Clause 28. The device of clause 27, further comprising: means for generating a data structure that sorts the set of software components by file system path length, wherein an order in which each software component in the set of software components is populated in the runtime SBOM is based on the data structure.

Clause 29. The device of clause 28, wherein the order is from a shortest file system path length to a longest file system path length.

Clause 30. The device of any of clauses 21 to 29, wherein the one or more actions comprise reporting the runtime SBOM to a vulnerability management system.

Clause 31. A non-transitory computer-readable medium storing computer-executable instructions that, when executed by a device, cause the device to: populate a first software component that is configured for execution on the device as a first common-path root node of a runtime software bill of materials (SBOM); enumerate a first set of software sub-components associated with the first software component; populate, in the runtime SBOM, each software sub-component of the first set of software sub-components as a dependent node of the first common-path root node; and perform one or more actions associated with the runtime SBOM.

Clause 32. The non-transitory computer-readable medium of clause 31, wherein the first software component corresponds to an application, a library or a component.

Clause 33. The non-transitory computer-readable medium of any of clauses 31 to 32, wherein the first set of software sub-components comprises at least one application, at least one library, at least one component or any combination thereof.

Clause 34. The non-transitory computer-readable medium of any of clauses 31 to 33, wherein the enumerating is performed based on indexing of file system substrings associated with the first software component.

Clause 35. The non-transitory computer-readable medium of any of clauses 31 to 34, wherein the first software component corresponds to a software sub-component of another software component.

Clause 36. The non-transitory computer-readable medium of any of clauses 31 to 35, further comprising computer-executable instructions that, when executed by the device, cause the device to: populate a second software component that is configured for execution on the device as a second common-path root node of the runtime SBOM; enumerate a second set of software sub-components associated with the second software component; and populate, in the runtime SBOM, each software sub-component of the second set of software sub-components as a dependent node of the second common-path root node.

Clause 37. The non-transitory computer-readable medium of any of clauses 31 to 36, further comprising computer-executable instructions that, when executed by the device, cause the device to: enumerate a set of software components comprising the first software component and at least one other software component, wherein each software component in the set of software components is populated of the runtime SBOM as a respective common-path rood node.

Clause 38. The non-transitory computer-readable medium of clause 37, further comprising computer-executable instructions that, when executed by the device, cause the device to: generate a data structure that sorts the set of software components by file system path length, wherein an order in which each software component in the set of software components is populated in the runtime SBOM is based on the data structure.

Clause 39. The non-transitory computer-readable medium of clause 38, wherein the order is from a shortest file system path length to a longest file system path length.

Clause 40. The non-transitory computer-readable medium of any of clauses 31 to 39, wherein the one or more actions comprise reporting the runtime SBOM to a vulnerability management system.

Those skilled in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those skilled in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted to depart from the scope of the various aspects and embodiments described herein.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The methods, sequences, and/or algorithms described in connection with the aspects disclosed herein may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of non-transitory computer-readable medium known in the art. An exemplary non-transitory computer-readable medium may be coupled to the processor such that the processor can read information from, and write information to, the non-transitory computer-readable medium. In the alternative, the non-transitory computer-readable medium may be integral to the processor. The processor and the non-transitory computer-readable medium may reside in an ASIC. The ASIC may reside in an IoT device. In the alternative, the processor and the non-transitory computer-readable medium may be discrete components in a user terminal.

In one or more exemplary aspects, the functions described herein may be implemented in hardware, software, firmware, or any combination thereof. If implemented in software, the functions may be stored on or transmitted over as one or more instructions or code on a non-transitory computer-readable medium. Computer-readable media may include storage media and/or communication media including any non-transitory medium that may facilitate transferring a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line, or wireless technologies such as infrared, radio, and microwave, then the coaxial cable, fiber optic cable, twisted pair, digital subscriber line, or wireless technologies such as infrared, radio, and microwave are included in the definition of a medium. The term disk and disc, which may be used interchangeably herein, includes CD, laser disc, optical disc, DVD, floppy disk, and Blu-ray discs, which usually reproduce data magnetically and/or optically with lasers. Combinations of the above should also be included within the scope of computer-readable media.

While the foregoing disclosure shows illustrative aspects and embodiments, those skilled in the art will appreciate that various changes and modifications could be made herein without departing from the scope of the disclosure as defined by the appended claims. Furthermore, in accordance with the various illustrative aspects and embodiments described herein, those skilled in the art will appreciate that the functions, steps, and/or actions in any methods described above and/or recited in any method claims appended hereto need not be performed in any particular order. Further still, to the extent that any elements are described above or recited in the appended claims in a singular form, those skilled in the art will appreciate that singular form(s) contemplate the plural as well unless limitation to the singular form(s) is explicitly stated.

What is claimed is:

1. A method performed by a device, comprising:
populating a first software component that is configured for execution on the device as a first common-path root node of a runtime software bill of materials (SBOM);
enumerating a first set of software sub-components associated with the first software component;
populating, in the runtime SBOM, each software sub-component of the first set of software sub-components as a dependent node of the first common-path root node; and
performing one or more actions associated with the runtime SBOM.

2. The method of claim 1, wherein the first software component corresponds to an application, a library or a component.

3. The method of claim 1, wherein the first set of software sub-components comprises at least one application, at least one library, at least one component or any combination thereof.

4. The method of claim 1, wherein the enumerating is performed based on indexing of file system substrings associated with the first software component.

5. The method of claim 1, wherein the first software component corresponds to a software sub-component of another software component.

6. The method of claim 1, further comprising:
populating a second software component that is configured for execution on the device as a second common-path root node of the runtime SBOM;
enumerating a second set of software sub-components associated with the second software component; and
populating, in the runtime SBOM, each software sub-component of the second set of software sub-components as a dependent node of the second common-path root node.

7. The method of claim 1, further comprising:
enumerating a set of software components comprising the first software component and at least one other software component,
wherein each software component in the set of software components is populated of the runtime SBOM as a respective common-path rood node.

8. The method of claim 7, further comprising:
generating a data structure that sorts the set of software components by file system path length,
wherein an order in which each software component in the set of software components is populated in the runtime SBOM is based on the data structure.

9. The method of claim 8, wherein the order is from a shortest file system path length to a longest file system path length.

10. The method of claim 1, wherein the one or more actions comprise reporting the runtime SBOM to a vulnerability management system.

11. A device, comprising:
one or more memories;
one or more transceivers; and
one or more processors communicatively coupled to the one or more memories and the one or more transceivers, wherein the one or more processors, either alone or in combination, are configured to:
populate a first software component that is configured for execution on the device as a first common-path root node of a runtime software bill of materials (SBOM);
enumerate a first set of software sub-components associated with the first software component;
populate in the runtime SBOM, each software sub-component of the first set of software sub-components as a dependent node of the first common-path root node; and
perform one or more actions associated with the runtime SBOM.

12. The device of claim 11, wherein the first software component corresponds to an application, a library or a component.

13. The device of claim 11, wherein the first set of software sub-components comprises at least one application, at least one library, at least one component or any combination thereof.

14. The device of claim 11, wherein the enumerating is performed based on indexing of file system substrings associated with the first software component.

15. The device of claim 11, wherein the first software component corresponds to a software sub-component of another software component.

16. The device of claim 11, wherein the one or more processors, either alone or in combination, are further configured to:
populate a second software component that is configured for execution on the device as a second common-path root node of the runtime SBOM;
enumerate a second set of software sub-components associated with the second software component; and
populate in the runtime SBOM, each software sub-component of the second set of software sub-components as a dependent node of the second common-path root node.

17. The device of claim 11, wherein the one or more processors, either alone or in combination, are further configured to:
enumerate a set of software components comprising the first software component and at least one other software component,
wherein each software component in the set of software components is populated of the runtime SBOM as a respective common-path rood node.

18. The device of claim 17, wherein the one or more processors, either alone or in combination, are further configured to:
generate a data structure that sorts the set of software components by file system path length,
wherein an order in which each software component in the set of software components is populated in the runtime SBOM is based on the data structure.

19. The device of claim 18, wherein the order is from a shortest file system path length to a longest file system path length.

20. The device of claim 11, wherein the one or more actions comprise reporting the runtime SBOM to a vulnerability management system.

21. A non-transitory computer-readable medium storing computer-executable instructions that, when executed by a device, cause the device to:
populate a first software component that is configured for execution on the device as a first common-path root node of a runtime software bill of materials (SBOM);
enumerate a first set of software sub-components associated with the first software component;
populate, in the runtime SBOM, each software sub-component of the first set of software sub-components as a dependent node of the first common-path root node; and
perform one or more actions associated with the runtime SBOM.

22. The non-transitory computer-readable medium of claim 21, wherein the first software component corresponds to an application, a library or a component.

23. The non-transitory computer-readable medium of claim 21, wherein the first set of software sub-components comprises at least one application, at least one library, at least one component or any combination thereof.

24. The non-transitory computer-readable medium of claim 21, wherein the enumerating is performed based on indexing of file system substrings associated with the first software component.

25. The non-transitory computer-readable medium of claim 21, wherein the first software component corresponds to a software sub-component of another software component.

26. The non-transitory computer-readable medium of claim 21, further comprising computer-executable instructions that, when executed by the device, cause the device to:
populate a second software component that is configured for execution on the device as a second common-path root node of the runtime SBOM;
enumerate a second set of software sub-components associated with the second software component; and
populate, in the runtime SBOM, each software sub-component of the second set of software sub-components as a dependent node of the second common-path root node.

27. The non-transitory computer-readable medium of claim 21, further comprising computer-executable instructions that, when executed by the device, cause the device to:
enumerate a set of software components comprising the first software component and at least one other software component,
wherein each software component in the set of software components is populated of the runtime SBOM as a respective common-path rood node.

28. The non-transitory computer-readable medium of claim 27, further comprising computer-executable instructions that, when executed by the device, cause the device to:
generate a data structure that sorts the set of software components by file system path length,
wherein an order in which each software component in the set of software components is populated in the runtime SBOM is based on the data structure.

29. The non-transitory computer-readable medium of claim 28, wherein the order is from a shortest file system path length to a longest file system path length.

30. The non-transitory computer-readable medium of claim 21, wherein the one or more actions comprise reporting the runtime SBOM to a vulnerability management system.
